(19) United States
(12) Patent Application Publication
(10) Pub. No.: US 2008/0103851 A1
(43) Pub. Date: May 1, 2008

(54) Products and Processes for Determining Allocation of Inventory for a Vending Machine

(76) Inventors: Jay S Walker, Ridgefield, CT (US); Daniel E. Tedesco, Huntington, CT (US); Paul T. Breitenbach, Wilton, CT (US); Robert C. Tedesco, Fairfield, CT (US); Sih Y. Lee, Northvale, NJ (US); James A. Jorasch, Westport, CT (US)

Correspondence Address: WALKER DIGITAL MANAGEMENT, LLC, 2 HIGH RIDGE PARK, STAMFORD, CT, 06905, US

(21) Appl. No.: 11/719,429

(22) PCT Filed: Sep. 27, 2005
(86) PCT No.: PCT/US05/34528

§ 371 Date: Jul. 5, 2007

Related U.S. Application Data
(60) Provisional application No. 60/613,314, filed on Sep. 27, 2004.

(51) Int. Cl. G06Q 10/00

(52) U.S. Cl. 705/7

(57) ABSTRACT

According to an embodiment, an allocation of inventory for a vending machine (e.g., a mix or set of types of products and respective quantities of products to be loaded into a snack or beverage vending machine) is determined. In an embodiment, a computer or other computing device may be configured to (i) identify one or more vending machine products (e.g., from a universe of available products), (ii) determine an inventory allocation based on inventory management data associated with the products (e.g., data regarding the profitability of one or more particular products), and (iii) output an inventory allocation recommendation indicating an inventory allocation (e.g., a chart instructing an agent how to stock a particular vending machine). In various embodiments, inventory management data may comprise such criteria as slotting requirements, sales rates (e.g., the number of units of a particular product type sold per day), profitability (e.g., the retail price of a unit of a particular product type minus the unit cost of the product; the profit margin of a product type multiplied by a sales rate), outstanding product “subscription” data, seasonality considerations, weather considerations, product “tenure,” product mix (i.e., variety) considerations, expiration data, “soft demand” data (e.g., customers who have indicated a prospective willingness to purchase a product if stocked), and the like.

The present application claims the benefit of:

(i) International Application No. PCT2005/034528, filed Sep. 27, 2005 in the name of Walker Digital, LLC et al. entitled, PRODUCTS AND PROCESSES FOR DETERMINING ALLOCATION OF INVENTORY FOR A VENDING MACHINE; and

(ii) U.S. Provisional Patent Application No. 60/613,314, filed Sep. 27, 2004 in the name of Walker et al. entitled, APPARATUS, SYSTEM AND METHOD FOR DETERMINING VENDING MACHINE INVENTORY ALLOCATIONS.

The content of each of these applications is incorporated herein by reference.

### BRIEF DESCRIPTION OF THE FIGURES

FIG. 1 is a block diagram of an embodiment of a vending machine consistent with an embodiment of the present invention.

FIG. 2 is a block diagram of an embodiment of a system consistent with an embodiment of the present invention.

FIG. 3 is a diagram illustrating an example of the external appearance of a vending machine consistent with an embodiment of the present invention.

FIGS. 4A-B are tables illustrating exemplary data structures of an inventory database according to an embodiment of the present invention.

FIG. 5A-B is a table illustrating an exemplary data structure of a product database according to an embodiment of the present invention.

FIG. 6 is a table illustrating an exemplary data structure of a subscription account database according to an embodiment of the present invention.

FIG. 7 is a table illustrating an exemplary data structure of a product seasonality database according to an embodiment of the present invention.

FIG. 8 is a table illustrating an exemplary data structure of a product scoring database according to an embodiment of the present invention.

FIG. 9 is a table illustrating an exemplary data structure of a product ranking database according to an embodiment of the present invention.

FIG. 10 is a table illustrating an exemplary data structure of an allocation rules database according to an embodiment of the present invention.

FIG. 11 is a diagram illustrating an example of the appearance of an inventory allocation diagram consistent with an embodiment of the present invention.

### DETAILED DESCRIPTION

### Terms

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) embodiments of the disclosed invention(s)”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” encompasses both “based only on” and “based at least partially on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### Disclosed Examples are not Limiting

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s).

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Further, although process steps, algorithms or the like may be described in one or more particular sequential orders, such processes may be configured to work in different orders. In other words, any sequence or order of steps that may be explicitly described does not indicate a requirement that the steps be performed in that order. The steps of processes described herein may be performed in any order practical. Further, some steps may be performed simultaneously despite being described or implied as occurring non-simultaneously (e.g., because one step is described after the other step is described). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

### Determination

“Determining” something can be performed in a variety of manners and therefore the term “determining” (and like terms) includes calculating, computing, deriving, looking up (e.g., in a table, database or data structure), ascertaining and the like.

### Computing

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In an embodiment, hard-wired circuitry or custom hardware may be used in place of, or in combination with, software instructions for implementation of the processes of various embodiments. Thus, embodiments are not limited to any specific combination of hardware and software

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ microprocessor, that are adapted to communicate with the computer. Any number and type of machines may be in communication with the computer.

### Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

### DEFINITIONS USED HEREIN

Actual Sales Rate, Sales Rate—The rate at which a given product is sold by a vending machine. Such a sales rate is typically calculate with respect to sales during a sales period. A sales rate may be expressed in various units, such as units per time (e.g. 2.5 units of a particular product per day), profit per time, and sales dollars per time.

Fill Period—The period of time between restock dates.

Inventory Allocation—A description of products that are to be made available for sale by a vending machine (e.g., during an upcoming restock process). For example, a vending machine may comprise a number of rows into which several units of product (e.g., of a particular type) may be loaded (e.g., one row comprises Snickers®, while an adjacent row comprises Twix®). Thus, an inventory allocation may specify (i) which product types (e.g., as identified by a product identifier, as identified by categories of product such as a set of product identifiers from which one product identifier may be selected) are to be loaded into (and thus made available for sale by) a vending machine, and (ii) how many units (or ranges of units) of each type of product are to be made available for sale.

Inventory Allocation Diagram, Diagram, Inventory Allocation Recommendation, Planogram—An indication (e.g., a visual indication) of an inventory allocation, typically the indication is useful for an operator to utilize in loading a vending machine (e.g., when restocking the vending machine). In an embodiment, an inventory allocation diagram may comprise a chart or map (e.g., a printed image that shows a grid of rows, with both a product identifier and number of units of that product indicated for each row). In other embodiments, an inventory allocation diagram may comprise instructions for making products available for sale by a vending machine, such as a textual description of steps for loading a vending machine in accordance with a determined inventory allocation (e.g., “Load 15 units of Snickers® into row A-1,” etc).

Inventory Management Data, Product Data—Information that is useful in determining and/or affecting (partially or wholly) the sales and/or profits of one or more vending machines. Such sales and/or profits may be those attributable to certain products of a vending machine, all products of a vending machine, certain products of a plurality of vending machines, or all products of a plurality of vending machines. Such sales and/or profits need not be explicitly quantifiable, but may be, e.g., expressed relative to the other sales and/or profits (e.g., profits of another product). Such sales and/or profits need not be determinable with certainty; likely sales and/profits may be used. According to an embodiment, inventory management data may be used to determine a plan for stocking a vending machine with one or more products for a future sales period. In an embodiment, inventory management data includes one or more of the following:

1. Price data
a. Retail price
b. Wholesale price data

2. Cost data
a. Fixed cost data
b. Variable cost data
c. Labor cost data
d. Location cost data
   i. Real estate license or lease cost data
   ii. Electricity cost data
e. Product cost data
   i. Rebates or discounts available to vending machine operators from product manufacturers or suppliers
   ii. Volume discounts available to vending machine operators from product manufacturers or suppliers

3. Sales data
a. Sales totals (e.g. gross revenue)
   i. From one or more vending machines of an operator
   ii. From one or more vending machines of a second operator
   iii. From one or more retail stores
b. Velocity or sales rates (e.g., the number of units of a particular product type sold per unit of time)
c. Seasonality considerations
d. Outstanding product “subscription” data

4. Other demand data (e.g. indications of actual or potential interest in a product by one or more customers)
a. Affirmative requests for the purchase or stocking of particular products (“soft demand”)
b. Survey responses (e.g., as described with reference to U.S. Pat. Nos. 6,161,059, 6,317,649, and 6,658,323, the entirety of each of which is incorporated by reference herein)
c. Outstanding product “subscription” data
d. “Foot traffic” data (e.g. data obtained from a motion sensor or other device regarding the number of people who frequent the physical proximity of a vending machine within a given period of time)

5. Profit or “profitability” data
a. E.g., the retail price of a unit of a particular product type minus the unit cost of the product
b. E.g, the profit margin of a product type multiplied by a sales rate
c. E.g, “Profit contribution”, as described herein

6. Product “tenure”—the length of time or number of periods of time (e.g. sales periods or “fill” periods) that one or more products have been stocked in one or more vending machines

7. Vending machine inventory data—data regarding the current or anticipated inventory of one or more vending machines

8. Product mix (i.e., variety) considerations

9. Expiration data
a. Expiration time/dates of perishable products
b. Expiration time/dates of promotions

10. Information besides expiration data that is probative of the salability of a product

11. Business relationship data
a. Contractual or other relationships between vending machine operators and product manufacturers or suppliers
   i. Slotting requirements
b. Contractual or other relationships between vending machine operators and location owners
   i. Agreements to stock certain products
   ii. Agreements not to stock certain products (e.g., no chocolate in a school's vending machine)

12. Legal or regulatory data/rules
a. E.g., no cigarettes in schools

13. Vending machine location data
a. Demographics of customers (e.g. average age, gender, height, ethnicity, income, etc.)
b. Climate
c. Machine hardware considerations
   i. Inventory/storage capacity
   ii. Refrigeration capacity/capability
   iii. Output devices/advertising capability

14. Weather data
a. Temperature data
b. Forecast data

15. Energy requirements and energy costs
a. E.g., refrigeration costs for a cooling a product that requires storage in relatively cool temperatures.

16. Inventory “Requirements”
a. E.g., one or more rows must be stocked exclusively with promotional products, including near-expired products, free samples, and the like. In such an embodiment, rules may provide that certain products are required in particular rows (e.g., “promotional rows”), and/or may provide that certain products are to be allocated to such promotional rows based on profit and revenue management considerations (e.g. slow selling, soon to expire products are allocated to a promotional row). Thus, certain rows (e.g. row A-21) may be promoted as special price or “free product” rows.
b. Products from certain manufacturers may be allocated to particular rows (e.g. the M&M Mars company may required that its products are stocked in rows A1, A2 and A3, in order for an operator to be eligible to receive promotional rebates).

In an embodiment, inventory management data may be used to determine a score in association with one or more product types (e.g., if the Snickers® candy bar is relatively profitable, a relatively high “profitability” score is associated with that product type), such that the stocking of favorable products (e.g., relatively profitable products that have proven to sell well at a particular location) may, with reasonable likelihood, lead to an increase in the overall sales and/or profit of a vending machine.

Operator—The owner of a vending machine, or an agent (e.g., route driver) of the owner.

Product—A good or service provided by (e.g., dispensed or otherwise made available by) a vending machine. Examples of goods provided by vending machines include beverages (e.g., cans of soda) and snacks (e.g., candy bars). A product identifier may be associated with a type of product (e.g., Snickers® almond flavor 20 ounce candy bar is associated with the product identifier S-1). The two terms “type of product” and “product type” are used synonymously. A product is typically sold by a vending machine, and typically by the same vending machine that provides the product.

Profitability—An amount of profit that a vending machine operator may realize from the sale of one or more products. In an embodiment, the profitability of one or more products may be considered when determining a vending machine inventory allocation.

In an embodiment, the profitability of one or more products may be determined by subtracting a product's cost (e.g., unit cost) from its sale price. Thus, in an embodiment, determining profitability comprises determining a per-unit profit margin(s) for each of one or more products.

In an embodiment, determining the profitability of one or more products may comprise determining an “expected profitability” associated with a product. An expected profitability calculation may determine an amount of profit that a vending machine operator may expect to realize from the sale of one or more products over a given period of time (e.g., one fill period, two fill periods). Thus, in an embodiment, the expected profitability of a particular type of product (e.g., Snickers® candy bar) available for sale by a vending machine during a particular period of time (e.g., an upcoming fill period that starts Jan. 1, 2007 and ends Jan. 15, 2007) may be determined by multiplying the product's profit margin (e.g., if each unit of Snickers® candy bar is purchased by an operator for 40¢ and subsequently sold for 75¢, the profit margin is 35¢) by the number of units of product expected to sell (i.e., a sales forecast metric). Thus, an expected profitability calculation may have the effect of estimating an amount of profit associated with the stocking of one or more products.

In an embodiment, determining the profitability of one or more products may comprise determining a “profit contribution” associated with a product (e.g., a “profit contribution” of a product can be defined as: the portion of the sum of the gross margins for all units of all products sold by a vending machine, which portion is attributable to that product type).

Restock Date, Restock Time—The time and/or date that a vending machine is scheduled to be restocked with products (e.g., by an operator of the vending machine).

Row—A portion of a vending machine designed to store products for distribution (e.g., a portion of a shelf onto which products are loaded). In an embodiment, each row may include a respective dispensing mechanism (e.g., a helix mechanism). A row may include one or more product types. Each product in a particular row may be sold for the same price (e.g., $0.75 per unit). Each row may comprise a fixed or variable number of positions for accommodating products. In an embodiment, an identifier may be associated with each row of a vending machine (e.g., the row in the upper left-most corner may be identified by “A-1”). The identifier of a row may be based on the horizontal position of that row and the vertical position of that row. For example, the first character of the identifier of a row may be based on the horizontal position of that row, and the second character of the identifier of that row may be based on the vertical position of that row.

Sales Forecast, Sales Forecast Metric—An estimation of a number of products that may be sold by a vending machine during a particular period of time. Determining a sales forecast may take into consideration a variety of factors, including past sales rates and/or current sales rates; “soft demand” information which indicates demand for a product but is not actual sales of that product (e.g., soft demand include information from customers that indicating the customers' desire to purchase certain products in the future); outstanding “subscription” account data which indicates prepaid items and/or items guaranteed to be dispensed; and the like. In an embodiment, a sales forecast may be used to determine an expected profitability associated with a product type (e.g., over a fill period). In an embodiment, determining a sales forecast metric may take into consideration a product's actual historic sales rate (e.g., if Snickers® candy bar sold an average of 1.7 units/day during a previous fill period, Snickers® candy bar may be projected to sell at the same rate during an upcoming fill period at that vending machine, at similar locations, or at all vending machines).

Subscription, Subscription Account—A subscription account according to an embodiment permits a vending machine customer to receive a plurality of units of one or more products over a period of time. For example, a “pre-paid” subscription account may enable a customer to receive 10 units of Snickers® candy bar over the next month in exchange for the customer paying $5 at the time of establishing or renewing his prepaid subscription account. In an embodiment, a subscription account identifier may uniquely identify a customer (i.e., each customer is provided a unique subscription account identifier). Vending machine subscription accounts are described at length in Applicant's PCT Patent Application No. US 2004/041561, entitled PRODUCTS AND PROCESSES FOR ESTABLISHING MULTI-TRANSACTION RELATIONSHIPS WITH CUSTOMERS OF VENDING MACHINES, filed Dec. 9, 2004; U.S. Pat. No. 6,298,972, entitled METHOD AND APPARATUS FOR ESTABLISHING AND MANAGING VENDING MACHINE SUBSCRIPTIONS, issued Oct. 9, 2001; U.S. Pat. No. 6,085,888, entitled METHOD AND APPARATUS FOR ESTABLISHING AND MANAGING VENDING MACHINE SUBSCRIPTIONS, issued Jul. 11, 2000; U.S. Pat. No. 5,988,346, entitled METHOD AND APPARATUS FOR ESTABLISHING AND MANAGING VENDING MACHINE SUBSCRIPTIONS, issued Nov. 23, 1999; Patent Application No. US2004/041561, entitled PRODUCTS AND PROCESSES FOR ESTABLISHING MULTI-TRANSACTION RELATIONSHIPS WITH CUSTOMERS OF VENDING MACHINES, filed Dec. 9, 2004; and Patent Application No. 60/668,405, entitled PRODUCTS AND PROCESSES FOR ESTABLISHING MULTI-TRANSACTION RELATIONSHIPS WITH CUSTOMERS OF VENDING MACHINES, filed Dec. 9, 2004. The entirety of each of the above patents and patent applications is incorporated by reference herein as part of the present disclosure.

### Apparatus and System Architecture

Generally, a vending machine in accordance with an embodiment may comprise a device, or communicate with one or more devices (e.g., a server, a peripheral device, and/or a peripheral device server), that are configured to manage sales transactions with customers by, among other things, communicating product information to customers, receiving payment from customers, controlling the pricing and/or distribution of goods, and/or controlling entitlements to services.

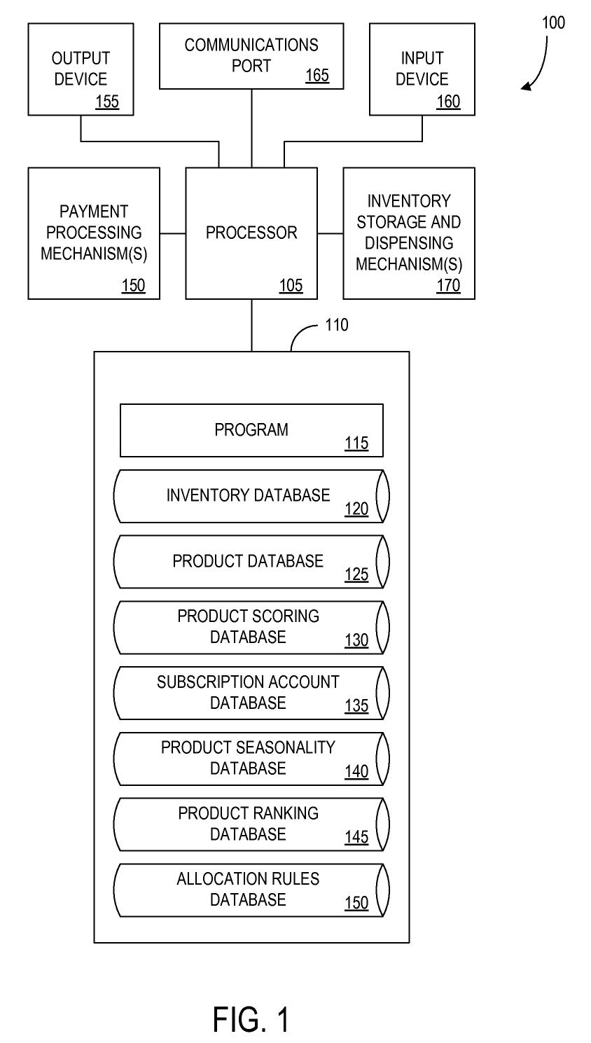

FIG. 1 is a block diagram of a vending machine 100 that may be operable to perform one or more functions described herein.

The vending machine 100 may include a processor 105, such as one or more Intel® Pentium® or Centrino™ microprocessors. The processor 105 (herein, “processor,” “processor 105”, “computer” or “control system”) may include or be coupled to one or more clocks or timers (not shown in FIG. 1). The processor may include one or more communication ports 165 through which the processor 105 may communicate, in accordance with an embodiment, with other devices such as one or more peripheral device servers, one or more servers, one or more peripheral devices, and/or one or more user devices. In an embodiment, a communication port 165 may comprise a modem (e.g. a cellular modem or otherwise), a network port, a wireless transmitter or wireless transponder (e.g. an infrared transmitter/receiver, a radio transmitter/receiver).

The processor 105 is also in communication with a data storage device 110. The data storage device 110 may include any appropriate combination of magnetic, optical and/or semiconductor memory. The data storage device may include, for example, additional processors, communication ports, Random Access Memory (“RAM”), Read-Only Memory (“ROM”), a compact disc, a hard disk drive, a CD reader and a CD writer. The processor 105 and the storage device 110 may each be, for example: (i) located entirely within a single computer or other computing device; or (ii) connected to each other by a remote communication medium, such as a serial port cable, a LAN, a telephone line, radio frequency transceiver, a fiber optic connection or the like. In an embodiment for example, the vending machine 100 may comprise one or more computers (or processors 105) that are connected to a remote server computer operative to maintain databases, where the data storage device 110 comprises the combination of the remote server computer and the associated databases.

The data storage device 110 stores a program 115 for controlling the processor 105. The processor 105 performs instructions of the program 115, and thereby operates in accordance with any one or more of the various methods described herein. A computer program 115 according to an embodiment may be developed using an object oriented language that allows the modeling of complex systems with modular objects to create abstractions that are representative of real world, physical objects and their interrelationships. However, it would be understood by one of ordinary skill in the art that various embodiments as described herein can be implemented in many different ways using a wide range of programming techniques as well as general purpose hardware systems or dedicated controllers.

The program 115 may be stored in a compressed, uncompiled and/or encrypted format. The program 115 furthermore may include program elements that may be generally useful, such as an operating system, a database management system and device drivers for allowing the processor 105 to interface with computer peripheral devices. Appropriate general-purpose program elements are known to one of ordinary skill in the art.

Further, the program 115 can be operative to execute a number of objects, modules and/or subroutines to implement various disclosed functions and structures.

According to an embodiment of the present invention, the instructions of the program 115 may be read into a main memory of the processor 105 from another computer-readable medium, such from a ROM to a RAM. Execution of sequences of the instructions in the program 115 causes processor 105 to perform the process steps described herein. In alternative embodiments, hard-wired circuitry or integrated circuits may be used in place of, or in combination with, software instructions for implementation of the processes described herein. Thus, embodiments of the present invention are not limited to any specific combination of hardware, firmware, and/or software.

In addition to the program 115, the storage device 110 is also operative to store one or more databases. As will be understood by one of ordinary skill in the art, any schematic illustrations and accompanying descriptions of any sample databases presented herein are exemplary arrangements for stored representations of information. It will be readily apparent that various other arrangements may be employed besides those suggested by the tables shown. Similarly, any illustrated entries of the databases represent exemplary information only; one of ordinary skill in the art will readily understand that the content of the entries and the number of entries can be different from those illustrated herein. Further, despite any depiction of the databases as tables or like structures, an object-based model could be used to store and manipulate the data types of the present invention and likewise, object methods or behaviors can be used to implement any or all disclosed processes.

Vending machine 100 may comprise payment processing mechanism(s) 150. The payment processing mechanism(s) 150 may comprise one or more mechanisms for receiving payment and dispensing change, including a coin acceptor, a bill validator, a card reader (e.g. a magnetic stripe reader) and a change dispenser.

In a manner that is well known in the art, a magnetic stripe card reader may read data on the magnetic stripe of a credit card or debit card, and may cooperate with conventional point-of-sale credit card processing equipment to, e.g., validate and otherwise process card-based purchases through a conventional transaction authorization network. Suitable card-based transaction processing systems and methods are available from USA Technologies, Inc., of Malvern, Pa.

The coin acceptor, bill validator and change dispenser may communicate with a currency storage apparatus (a “hopper”; not shown) and may comprise conventional devices such as models AE-2400, MC5000, TRC200 by Mars, Inc. of West Chester, Pa., or CoinCo model 9300-L.

The coin acceptor and bill validator may receive and validate currency that is stored by the currency storage apparatus. Further, a bill validator or coin acceptor may be capable of monitoring stored currency and maintaining a running total of the stored currency, as is discussed with reference to U.S. Pat. No. 4,587,984, entitled COIN TUBE MONITOR MEANS, the entirety of which is incorporated by reference herein as part of the present disclosure. The change dispenser activates the return of coinage to the customer when deemed appropriate to do so.

In an embodiment, a vending machine may be configured to receive payment authorization and product selection commands through a wireless device communication network, directly or indirectly, from a customer device (e.g. a cellular telephone). In such an embodiment, a payment processing mechanism may comprise a cellular transceiver operatively connected to a processor, as described herein. Systems and methods allowing for the selection of and payment for vending machine products using cellular telephones are provided by USA Technologies, Inc. Further, in such an embodiment, a customer cellular telephone may serve as an input/output device, as described herein. Further details concerning vending machine payment processing mechanisms are likewise well known.

The vending machine 100 may further comprise an output device 155 and an input device 160. Although only a single output device 155 and a single input device 160 is illustrated in FIG. 1, any number of output devices and/or input devices may be used.

In accordance with embodiments of the presenting invention, a vending machine may include an input device for receiving input from a customer, operator, or other person. Also, a vending machine may include one or more output devices for outputting product and/or other information to a customer or operator.

Many combinations of input and output devices may be employed in accordance with various embodiments of the present invention. For example, in embodiments described herein which include touch screens, input and output functionality may be provided by a touch screen. Thus a single device may perform some or all of the functionality of both an input device and an output device

A vending machine may include more than one input device. For example, a vending machine may include (1) one or more input devices which are situated on the exterior of the vending machine and which are operable to receive customer input (e.g., a touch-sensitive LCD screen, a keypad with physical buttons), and (2) one or more input devices which are situated on the interior of the vending machine and which are operable to receive operator input. However, in an embodiment an input device provides the dual functionality of receiving input from both operators and customers.

As also described, a vending machine may comprise more than one output device. For example, a vending machine may include both a Liquid Crystal Display (LCD) screen and a plurality of Light Emitting Diodes (LEDs).

Output device 155 may comprise, for example, an LCD and/or one or more LEDs displays (e.g., several alphanumeric LEDs on the shelves of a vending machine, each LED proximate to or otherwise associated with a row of product inventory).

In an embodiment, an LED display screen may be mounted to a vending machine (e.g., attached thereto, such as via bolts or other mounting hardware). Such a mounted LED display screen and may be used to communicate messages (e.g., to customers, route drivers, etc.). A suitable LED display screen for such an embodiment may be housed in an aluminum case having a length of about 27.5″, a height of about 4.25″, and a depth of about 1.75″. Such a display screen may have a display area capable of showing up to a predetermined number of characters, such as up to thirteen alphanumeric and/or graphical characters. Further, such an LED display screen may comprise a serial computer interface, e.g., an RJ45/RS232 connector, for allowing a processor to direct the LED display area. Further still, such an LED display may be capable of outputting text and graphics in several colors (e.g., red, yellow, green) by directing the LEDs to go illuminate in those colors.

Further, in an embodiment, an output device comprises a printer. In an embodiment, a printer is operable to print on card stock paper (e.g. 0.06 mm to 0.15 mm thickness), such as the EPSON EU-T400 Series Kiosk Printer. Further, a printer may be capable of thermal line printing various alphanumeric and graphical symbols in various font sizes (e.g. ranging from 9 to 24 point) on various types of paper. Additionally, such a printer may communicate with a processor, e.g., via an RS232/IEEE 12834 and/or bi-directional parallel connection and print as directed to by the processor. Such a printer may further comprise a buffer, such as a 4 KB data buffer.

Additionally, in an embodiment, an output device comprises an audio device, such as an audio speaker, that audibly outputs information to customers. Speakers may comprise speakers with conventional audio frequency output ranges or hypersonic speakers.

Input device 160 may comprise one or more of (1) a set of alpha-numeric keys for providing input to the vending machine, such as the Programmable Master Menu® Keypad, (2) a selector dial, (3) a set of buttons, each of which is associated with a respective item dispenser, (4) a motion sensor, (5) a barcode reader, (6) a Dual-Tone Multi-Frequency (DTMF) receiver/decoder, (7) a wireless device (e.g. a cellular telephone or wireless Personal Digital Assistant), (8) cameras, such as digital video and/or digital still photographic cameras, (9) a microphone and/or a voice recognition module, (10) a fingerprint reader, (11) a topical facial pattern scanner/reader, (12) an iris or retinal scanner, (13) an infrared receiver, (14) a fingerprint reader, and/or (15) any other device capable of receiving a command or other data from a user and transmitting the command or data to a processor. Accordingly, the processor can be programmed to receive and interpret data provided by various types of input devices.

As described, in an embodiment, a touch-sensitive screen may be employed to perform both input and output functions. Suitable and commercially available touch screens for use in accordance with the present invention are manufactured by Elo TouchSystems, Inc., of Fremont, Calif., such as Elo's AccuTouch™ series touch screens. Such touch screens may comprise: (i) a first (e.g., outer-most) hard-surface screen layer coated with an anti-glare finish, (ii) a second screen layer coated with a transparent-conductive coating, (iii) a third screen layer comprising a glass substrate with a uniform-conductive coating. Further, such touch screens may be configured to detect input within a determined positional accuracy, such as a standard deviation of error less than ±0.080-inches (2 mm). The sensitivity resolution of such touch screens may be more than 100,000 touchpoints/in² (15,500 touchpoints/cm²) for a 13-inch touch screen. For such touch screens, the touch activation force required to trigger an input signal to the processor (described herein) via the touch screen is typically 2 to 4 ounces (57 to 113 g). Additionally, touch screens for use in accordance with embodiments of the present invention may be resistant to environmental stressors such as water, humidity, chemicals, electrostatic energy, and the like. These and other operational details of touch screens (e.g., drive current, signal current, capacitance, open circuit resistance, closed circuit resistance, etc.) are well known.

Vending machine 100 may further comprise one or more inventory storage and dispensing mechanisms 170. Product inventory storage and product dispensing functions of a vending machine configured in accordance with a snack machine embodiment of the present invention may include one or more of: (i) a drive motor, (ii) metal shelves, (iii) a product delivery system (e.g. a chute, product tray, product tray door, etc.), (iv) single or dual spiral (i.e. double helix) item dispensing rods, (v) convertible (i.e. extendable) shelves, and/or (vi) a refrigeration unit.

In an embodiment, a vending machine may be housed in a casing of the model 129 SnackShop manufactured by Automatic Products™. In such embodiments, 3 removable shelves may be employed, together providing the vending machine with 30 product rows and an inventory capacity of between 185 to 522 commonly vended snack products.

Inventory storage and dispensing mechanisms 170 may comprise one or more of: (i) metal and/or plastic shelving, (ii) item dispensing actuators/motors, (iii) product delivery chutes, and/or (iv) a refrigeration unit. Further details concerning vending machine inventory storage and dispensing mechanisms are well known.

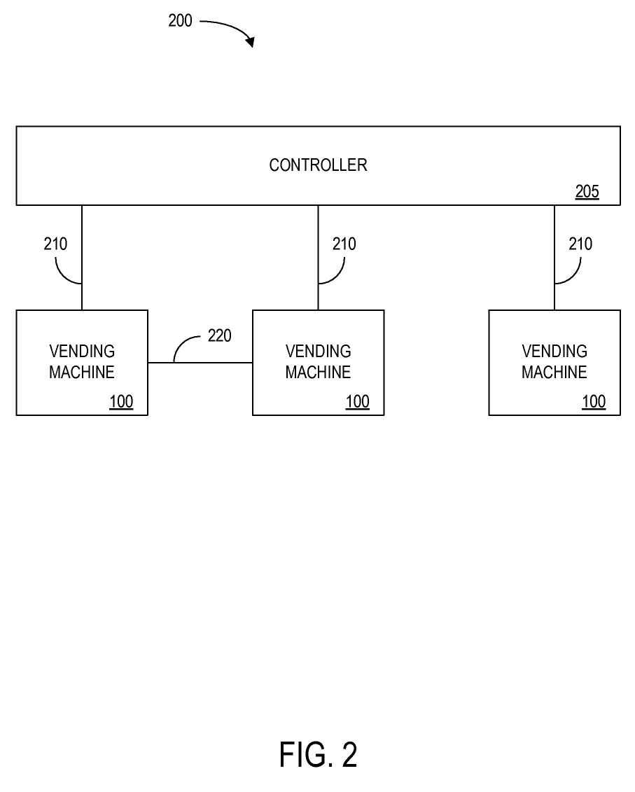

Referring to FIG. 2, a block diagram of a system 200 according to an embodiment includes a controller 205 that is in communication, via a communications network 210, with one or more vending machines 100. The controller 205 may communicate with the vending machines 100 directly or indirectly, via a wired or wireless medium such as the Internet, LAN, WAN or Ethernet, Token Ring, or via any appropriate communications means or combination of communications means.

Each of the vending machines 100 may comprise computers (such as those based on the Intel® Pentium® or Centrino™ microprocessor) that are adapted to communicate with the controller 205. Further, in an embodiment, a controller 205 may comprise one or more computers, such as those based on the Intel® Pentium® processor, that may or may not be located remotely to one another or remotely to one or more of the vending machines 100. Thus, in an embodiment, a controller 205 may facilitate the transmission of data between one or more vending machines 100 and one or more operator computers (not shown in FIG. 2) so that human operators may remotely interact with vending machines and/or vending machine customers. Further still, in an embodiment, system 200 includes a user device (not shown in FIG. 2) that enables customers to transmit data to and/or receive data from a vending machine 100 and/or controller 205.

Any number and type of vending machines 100 may be in communication with the controller 205. Communication between the vending machines 100 and the controller 205, and among the vending machines 100 (which communicate via communication network 220), may be direct or indirect, such as via the Internet, via a Web site maintained by controller 205 on a remote server, or via an on-line data network including commercial on-line service providers, bulletin board systems and the like. In yet other embodiments, the vending machines 100 may communicate with one another and/or controller 205 via radio frequency (RF) signals, cable TV transmissions, satellite transmissions and the like.

Some possible communication networks that may be included in network 210 and/or network 220 or otherwise be part of system 200 include: a local area network (LAN), a wide area network (WAN), the Internet, a telephone line, a cable line, a radio channel, an optical communications line, a satellite communications link. Possible communications protocols that may be part of system 200 include: Ethernet (or IEEE 802.3), SAP, ATP, Bluetooth™, and TCP/IP. Communication may be encrypted in any of a variety of well-known ways in order to ensure privacy and/or prevent fraud.

In an embodiment, the controller 205 may not be included. For example, an embodiment may be practiced on a stand-alone vending machine 100 and/or a vending machine 100 in communication with only one or more other vending machines 100. Any functions described as being performed by the controller 205 or data described as being stored on the controller 205 may instead be performed by or stored on one or more vending machines 100.

In the embodiment of FIG. 2, some of the functionality described with reference to FIG. 1 as being performed by vending machine 100 may instead or in addition be performed by controller 205. Similarly, any data described with reference to FIG. 1 as being stored in a memory of vending machine 100 may, in the embodiment of FIG. 2, be instead or in addition stored in a memory of controller 205.

Accordingly, in an embodiment, a controller 205 may perform processes described herein, such that the controller provides an operator with an inventory allocation. Thus, an operator may obtain an inventory allocation prior to having a loading process performed (e.g., before trucks are dispatched from a central facility such that one or more particular machines may be restocked).

In an embodiment, the input device of a vending machine may include personal computer or like computing device that is accesses the controller (e.g., via a web site operated by or on behalf of the controller). Such an input device may be operable allow the operator to provide the controller, via the web site, with data such as inventory management data (e.g., the location of certain vending machines, the type of vending machines, sales data).

The personal computer can likewise perform the functions of an output device, and provide the operator (e.g., via the same web site, via a different web site) with an indication of a determined inventory allocation (as described herein). Such inventory allocations may be, e.g., displayed on a screen of the personal computer, printed by a printer in communication with the personal computer, downloaded to a file on the hard drive of the personal computer, and the like.

The personal computer (or like computing device) may perform the aforementioned input and output functions (e.g., allow the operator to provide inventory management data, allow the operator to receive inventory allocations) via a web site. The personal computer can run web browser software (which may be modified by various plug-ins and other enhancements in a well known manner) which allows the personal computer to access a web site (e.g., a web site run by the controller). The web browser can generate forms (e.g., HTML forms) or other web page interfaces that permit the entry of data via the web browser. The web browser can also display a wide variety of output data (e.g., text, images, multimedia) which conveys the inventory allocations to the operator in any of a number of manners.

In such an embodiment, inventory allocations may be provided to operators via the Internet (e.g., via a web site). Further, if the controller serves to collect inventory management data from a plurality of vending machines of different operators, then the controller may provide various operators with data those operators would not have had available. For example, sales data from vending machines of a first operator may be made available to a second operator (directly, or indirectly as via an inventory allocation). Sales data (and other inventory management data) for similar vending machines of different operators may be shared, allowing an operator to take advantage (e.g., via an inventory allocation) of information not readily available to him but for this sharing. Operators may, e.g., pay a subscription fee in order to have the inventory allocations generated on their behalf.

Another advantage of such an embodiment is the ability to aggregate the product needs and inventory allocations of a plurality of operators, thereby allowing those operators to collectively bargain, e.g., with product manufacturers and product distributors. Thus, operators may obtain significant volume discounts from product manufacturers and/or product distributors. Further, proposed inventory allocations could be made available to product manufacturers, which might then react by offering better prices to the operators (e.g., in an attempt to have the manufacturer's products more prominently featured in the inventory allocations of those operators) or by offering rebates and other benefits in exchange for preferential treatment.

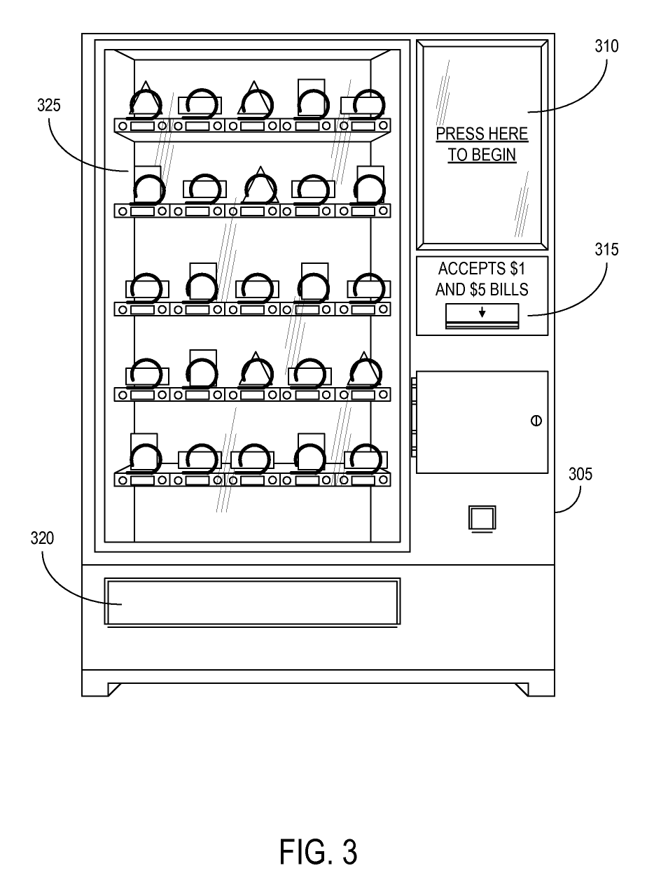

Referring to FIG. 3, a diagram of an embodiment 300 of the external appearance of an exemplary vending machine 100 is illustrated. The embodiment 300 includes (i) a cabinet 305, (ii) an input/output device 310 for receiving information from a customer and/or outputting text and/or graphical information to a customer, (iii) a payment processing mechanism 315, (iv) an inventory dispensing mechanism 320, and (iv) a product display window 325 behind which are visible the products available for sale by the vending machine and the product storage mechanism that holds those products within the vending machine.

Various cabinet designs are well known. Cabinet 305 may be constructed from, for example, any combination of (1) commercial grade (e.g., sixteen-gauge) steel (e.g., for exterior panels and internal shelving), (2) transparent materials such as glass or Plexiglas (e.g., for product display window 325), (3) rubber (e.g., for waterproofing insulation), (4) plastic, (5) aluminum, and/or (6) any suitable material.

Many commercially available machine cabinets can be used (as is, or with straightforward modifications) in accordance with various embodiments. For example, in snack machine embodiments, a suitable machine casing may comprise the 129 SnackShop™ manufactured by Automatic Products International, Ltd.™ of Saint Paul, Minn., which stands at 72″/1829 mm wide, has a width of 38⅞″/988 mm, and a depth of 35″/889 mm. Other suitable snack machine casings include the A La Carte™ machine from Automatic Products™, and the GPL SnackVendor™ model #159 from Crane Merchandising Systems/Crane Co.™ of Stamford, Conn.

In beverage machine embodiments, machine cabinets commercially available from Dixie Narco™, Inc. of Williston, S.C. may be employed. Beverage machine cabinets may comprise a “cooler” or “glass front” style front panel, featuring a transparent front panel (e.g. glass) enabling customers to see inventory for sale. Alternatively, beverage machine casings may comprise a “bubble front” style front panel, featuring a decorative front panel, typically used to advertise a logo of a product manufacturer commercially interested in the vending machine's operation.

Other embodiments are contemplated as well, including combination snack and beverage vending machine embodiments, such as those available from Crain Co.™. Further details concerning the suitability of machine casing/cabinetry are well known in the art, and need not be described in further detail herein.

Payment processing mechanism 315 may comprise any or all of the components described with reference to payment processing mechanism 150 (FIG. 1). Similarly, product dispensing mechanism 320 may comprise any or all of the components suitable for dispensing products described above with reference to inventory storage and dispensing mechanism 170 (FIG. 1).

### Process Steps

Following is a description of process steps of a method of an embodiment. The process steps may be performed by (i) a vending machine, (ii) a controller, (iii) peripheral devices, (iv) any other suitable computer devices, and/or (v) any combination thereof. Thus, it is contemplated that the steps may be performed by any combination of the devices and computers described herein. Additionally, the steps of the invention may be performed in any order, and thus are not limited to the order in which they are described.

### Step 100: Identify One or More Vending Machine Products

In an embodiment, a variety of product types may be available for stocking in one or more particular vending machines. For example, an operator may maintain a warehouse that stores a large number of products types.

In various situations, the number of product types an operator may have access to is larger than the number of product types that may be conveniently stocked in a vending machine. For example, if only one product may be loaded per row of a particular vending machine model, and the vending machine comprises twenty rows, an operator having access to more than twenty product types must decide which product types to load and thus made available for sale by the vending machine. Further, an operator may choose to stock the same product type in more than one row. Thus, in an embodiment, determining an inventory allocation in step 200 (described in further detail below) may comprise determining (i) which product types are to be loaded into a vending machine (e.g., as identified by a product identifier), and (ii) how many units of each type of product are to be loaded (e.g., how many rows the product type will occupy).

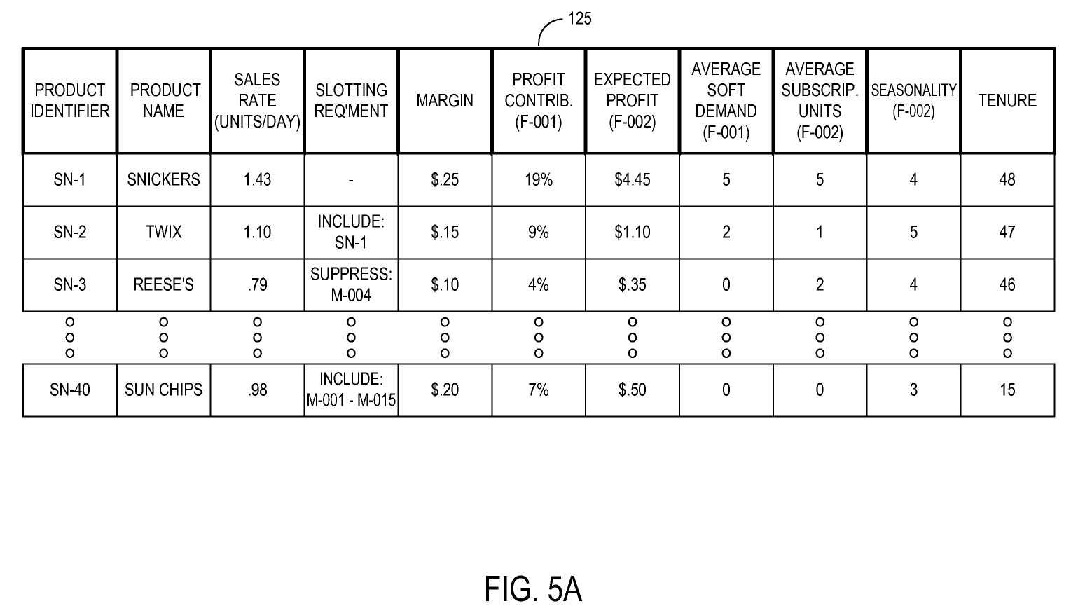

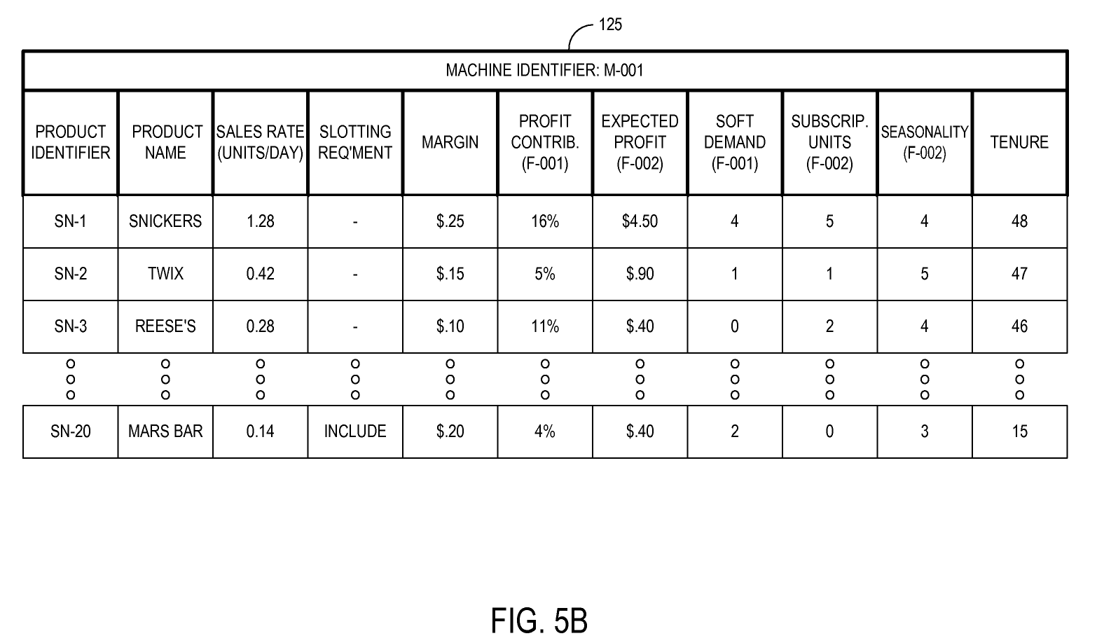

Accordingly, a product database 125 may be maintained (e.g., a computer device maintained at a central facility stores a product database, an exemplary data structure of which is depicted by FIG. 5A), for example, by an operator. The product database may contain data describing all product types available to an operator (e.g., the product types may be identified by unique product identifiers, and there are product identifiers for each product maintained at a central warehouse). Such a product database 125 may be updated (e.g., on a periodic basis, on a continual basis) with data that is associated with one or more product types available for sale by any of a plurality of vending machines.

Thus, turning to the exemplary product database 125 depicted by FIG. 5A, a “sales rate” of Snickers® candy bar may be determined in association with a plurality of vending machines during a particular period of time (e.g., during one or more fill periods). For example, a controller may determine a sales rate associated with a particular product type sold via a first machine (e.g., Snickers® candy bar is selling in machine M-001 at a rate of 1.37 units/day), determine a sales rate associated with that product type sold via a second machine (e.g., Snickers® candy bar is selling in machine M-002 at a rate of 1.49 units/day), and calculate the average of the two sales rates to determine an overall sales rate (e.g., 1.43 units/day). The calculation of the average may assign different weights to the two component sales rates, and thus calculate a weighted average. Thus, an operator may maintain inventory management data for all products available to the operator, such that the operator may determine in step 200 an inventory allocation based on that data.

In an embodiment, a product database 125 may maintain product data that is specific to one or more particular vending machines (e.g., profitability data associated with a product type loaded into a particular vending machine during a particular fill period). For example, turning to an alternate exemplary data structure of a product database 125 as depicted by FIG. 5B, an operator may maintain a product database associated with a particular vending machine (e.g., vending machine M-001). Such a database may contain inventory management data associated with one or more product types loaded into a particular vending machine (e.g., a computer device maintained at a central facility is periodically or continuously updated with inventory management data particular to one or more vending machines). Thus, an operator may maintain inventory management data for product types available for sale via a specific vending machine, such that the operator may determine in step 200 an inventory allocation based on that data.

In this manner, step 100 may comprise determining one or more product types (e.g., product types that are available to an operator, product types that have been loaded into one or more particular vending machines).

### Step 200: Determine an Inventory Allocation Based on Inventory Management Data Associated with the Identified Products

In an embodiment, inventory allocation of a vending machine may be determined based on inventory management data associated with one or more product types that can be made available for sale by the vending machine. In an embodiment, inventory management data describes various attributes (e.g., profitability) associated with such products, such that the stocking of certain products may lead to an increase in the overall sales and/or profits of a vending machine.

In an embodiment, when determining an inventory allocation (e.g., associated with a particular machine for an upcoming fill period), it may be beneficial to rank a number of available product types (e.g., during a scoring/ranking process described further herein) based on inventory management data. Further, it may also be beneficial to determine a number of units/rows associated with each product type, based on the inventory management data. Several of types of inventory management data, and various processing of that inventory management data, are described immediately below, followed by manners of employing inventory management data in order to determine inventory allocation of a vending machine.

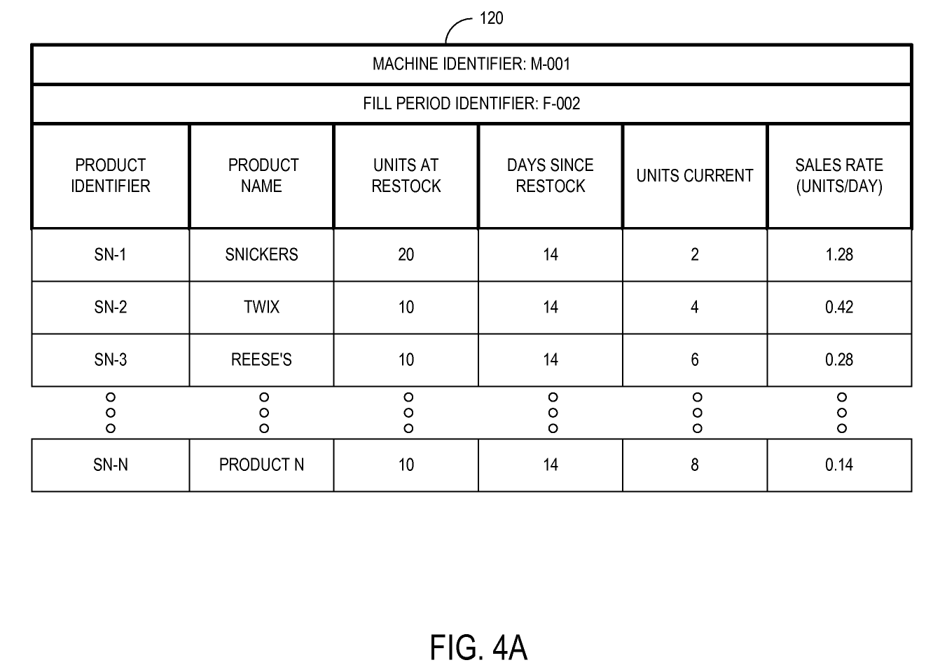

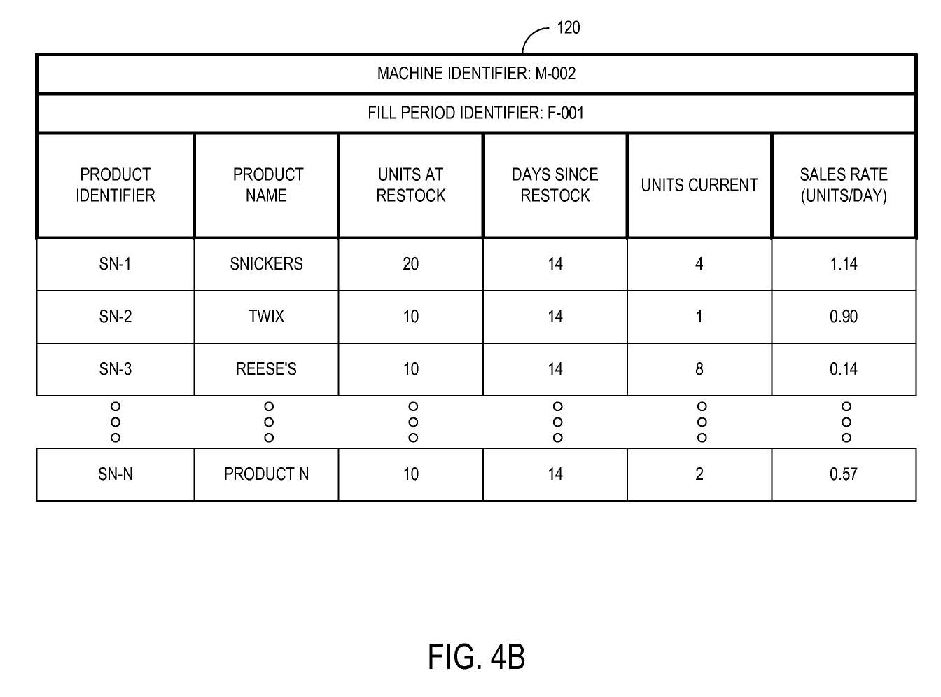

Inventory/Sales data. In an embodiment, determining an inventory allocation comprises receiving inventory data associated with one or more products that have been loaded into a particular vending machine (e.g., as identified by a unique vending machine identifier, such as “M-001”). For example, in an embodiment, a data storage device 110 located within a vending machine may store a database, such as an inventory database 120 depicted by FIG. 4A.

Turning to FIG. 4A, in an embodiment, information may be written to an inventory database 120 regarding one or more products loaded into the machine. For example, a route driver may stock a vending machine with products at the beginning of a fill period. At this point, the route driver may transmit inventory data to the vending machine (e.g., the route driver enters inventory information using a peripheral device such as a PDA, and/or using a vending machine input device such as a touch screen or keypad), such that a product identifier (e.g., “SN-1”) and a product quantity may be associated with each product type loaded into the vending machine (e.g., as shown by FIG. 4A, a route driver may indicate that twenty units of product SN-1 were loaded into machine M-001 during the restocking process associated with fill period F-002). After the operator concludes the restocking process, the vending machine may then be configured to write various data to the inventory database 120 during the fill period, such as the number of days that have elapsed since the restock (e.g., 14 days), the number of units of a particular product type currently in stock and/or the number of units of a particular product type that have been sold within the fill period (e.g., each time a unit is sold, the count of the number of units is decreased by one, such that if 20 units of Snickers® candy bar were originally loaded and 18 have sold, the database may reflect that 2 units currently remain in stock), and so on. Further, a vending machine may determine and record a sales rate associated with a product type (e.g., by dividing the number of units sold during the period of time by the number of days that have elapsed during the period of time).

In an embodiment, inventory data recorded by a vending machine may then be transmitted to a controller. Such transmission may occur in a variety of manners. For example, in an embodiment, a route driver may gather inventory data from a vending machine by connecting a peripheral device (e.g., a portable USB memory device such as the 256 MB JumpDrive 2.0 Pro, manufactured by Lexar Media, Inc., of Freemont, Calif.) to a suitable port of the vending machine, and the vending machine is operable to automatically transmit data to the connected peripheral device. The route driver may then later transmit inventory data to a controller (e.g., a computer located at a central operator facility) by using the peripheral device (e.g., by connecting the peripheral device to a port of the controller). In other embodiments, a vending machine and controller may be part of the same network (e.g., as demonstrated by FIG. 2). In such embodiments, a vending machine may transmit inventory data directly to a controller using communications network 210. As stated, such data transmission may occur on a periodic or substantially continuous basis.

Further, such an inventory database may be maintained in a variety of locations. As stated, in an embodiment, an inventory database may be maintained within a vending machine. In other embodiments, an inventory database may be maintained within a controller and/or peripheral device. In an embodiment comprising a group of networked vending machines (an example of which is depicted by FIG. 2), one particular vending machine may store inventory data associated with all vending machines within the network (e.g., a first vending machine is configured to transmit data to a second vending machine via communication network 220).

Still further, a controller may be maintained in a variety of locations. As stated, in an embodiment, a controller may comprise a computer maintained at a central operator facility. In other embodiments, a controller may comprise a peripheral device (e.g., PDA) and/or laptop computer that may be transported by a route driver to a variety of vending machine locations. In further embodiments, a vending machine may comprise a controller, such that any/all process steps described herein may be performed exclusively by a vending machine (e.g., a vending machine is programmed to record inventory data, determine inventory allocations, output a determined inventory allocation, and so on).

Thus, in this manner, a controller may receive inventory data associated with one or more products. In an embodiment, data used to determine an inventory allocation (i.e., inventory management data or product data) may comprise inventory data associated with a particular vending machine. Thus, in an embodiment, a controller may receive inventory data associated with all of the products loaded into a particular vending machine during a current or recent fill period (e.g., a controller receives sales rates associated with all of the products loaded into vending machine M-001 during a current fill period, as demonstrated by FIG. 5B). Alternately or additionally, a controller may receive aggregate inventory data associated with a product type loaded into a plurality of vending machines (e.g., a controller receives an overall sales rate for Snickers® candy bars gathered from a plurality of vending machines, as illustrated by FIG. 5A). Further, a controller may determine historic inventory data associated with a product type (e.g., a “lifetime sales rate” or other metric associated with a plurality of fill periods).

In an embodiment, a customer may desire a product that is out of stock, but the customer may then purchase a substitute good during the same transaction (e.g., the customer inserts $1.00, attempts to purchase Diet Coke® soda, learns the product is out of stock, and subsequently selects Diet Sprite® soda). In an embodiment, such substitute good sales may be treated separately from standard sales (e.g., a “substitute sales total” associated with Diet Sprite® soda, rather than a standard sales total, is increased in a product database 125 to reflect the sale of Diet Sprite® soda as a substitute product). In this manner, such substitute inventory data may be weighted differently from standard inventory data when determining an inventory allocation (e.g., a weight metric associated with substitute sales is lower than a weight metric associated with standard sales), such that demand may be more accurately measured (e.g., the customer desired Diet Sprite® soda only as a second choice).

Slotting Requirement Data. When determining an inventory allocation, a controller may consider slotting requirement data, which may describe (i) one or more products that must be included as part of an inventory allocation, and/or (ii) one or more products that must be suppressed from an inventory allocation. In an embodiment, slotting requirement data may be input by an operator (e.g., an operator uses a computer device such that fields of a product database 125 are populated).

In an embodiment, as detailed further herein, a slotting requirement may indicate that one or more product types (and possibly certain minimum quantities of such product types) must be included (e.g., without consideration of other factors such as profitability of those product types) as part of an inventory allocation. In one example, a vending machine operator may receive payment from a product manufacturer to ensure that (i) one or more particular product types are consistently loaded into one or more vending machines maintained by the operator (e.g., the operator agrees to stock at least one row of Snickers® candy bars during every vending machine restock, the operator agrees to stock at least one full row of Snickers® candy bars during every vending machine restock), and/or (ii) a predetermined number of units of a particular product type must be loaded into one or more vending machines maintained by the operator within a given time period (e.g., the operator agrees to stock 2,000 units of Snickers® candy bars over the course of the next year). Thus, as identified in a product database 125 depicted by FIG. 5A, a “slotting requirement” record associated with the product type SN-1 (Snickers® candy bar) may be given a rating of “include” with respect to one or more vending machine identifiers (e.g., turning to FIG. 5A, Sun Chips® are included in machines M-001-M-015). In another example, a product type may have achieved a tenure status such that the product may be given an “include” rating (e.g., certain long-standing products, such as Diet Coke® soda, may be required as part of an inventory allocation). In yet another example, it may be desirable that one or more products loaded into a vending machine characterized by a particular brand (e.g., a “Pepsi®” vending machine) must be of the same brand (and this requirement is a type of “brand agreement” consideration). Thus, a product type may be given an “include” rating if a brand agreement condition is satisfied (e.g., Pepsi® must be included in every Pepsi®-branded vending machine).

In other embodiments, a slotting requirement may indicate that a product type must be suppressed from (and thus not included at all in) an inventory allocation. In an embodiment, if a particular vending machine bears the insignia of a certain manufacturer (e.g., Pepsi®), any products not manufactured by Pepsi® or a Pepsi® affiliate may not be loaded into the machine (i.e., a “brand disagreement” consideration is satisfied). In other embodiments, any products distributed by a competitor of the manufacturer (e.g., the Coca-Cola® Company) may be suppressed (e.g., Diet Coke® soda may be given a “suppress” rating).

In an embodiment, a slotting requirement may comprise a product “mix” or variety consideration. A variety of such considerations are contemplated. In an embodiment, a product mix consideration may be based on a “complimentary product rule.” For example, turning to a product database 125 depicted by FIG. 5A, an operator may populate a record associated with a product type (e.g., Coke® soda) such that a required complimentary product (e.g., Snickers® candy bar) may be included as part of an inventory allocation. In this manner, an operator may assure that complimentary products are loaded into one or more vending machines. In another embodiment, it may be desirable for an inventory allocation to include at least a certain number of products from particular categories (e.g., a snack machine must include at least one “gum” product and at least one “chips” product). Accordingly, a product database 125 may comprise a “category” field associated with a product type (e.g., Snickers® candy bar is included in the “candy” category). Such category data may be used when determining an inventory allocation as described further herein. Categories may, but need not, be defined such that each product is not included in more than one category.

Scores associated with various “slotting requirement” scores may represent an absolute indication as to whether or not a product should be included as part of an inventory allocation; a “slotting requirement” rating of “suppress” may indicate that a product may not be included regardless of its score in any other category. By contrast, in another embodiment a “profitability” score of “1/10” may indicate that a product is relatively less profitable than other products, though the product may still be included (e.g., if scores associated with other inventory management data are high).

Profitability Data. In an embodiment, inventory management data may comprise profitability data. As stated, profitability may describe an amount of profit that a vending machine operator may realize from the sale of one or more products. In an embodiment, an operator may provide profitability data (e.g., an operator uses a computer device such that fields of a product database 125 are populated). Alternately or additionally, such data may be received from one or more vending machines in a manner described herein (e.g., inventory and/or margin data are received via communications network 210). As stated, such data may be associated with (i) a particular vending machine (e.g., M-001), and/or (ii) a plurality of vending machines (e.g., M-001 through M-015).

In an embodiment, the profitability of one or more products may be determined by subtracting a product's unit cost from the product's selling price (i.e., a per-unit profit margin is determined). In an embodiment, a profit margin associated with a product type (e.g., which is identified by a product identifier) may be stored as a record of a product database 125 (e.g., see FIG. 5A). Further, in an embodiment, a scoring process may determine a “profitability” score associated with a product type based on the product type's per-unit profit margin (e.g., a plurality of product types are each accorded a score, and subsequently ranked from highest to lowest score).

In other embodiments, determining the profitability of one or more products may comprise determining a “profit contribution” associated with a product type (e.g., where the profit contribution of a product type is the portion of the sum of the gross margins for all units of all products sold by a vending machine, which portion is attributable to that product type). For example, inventory data associated with a particular fill period (e.g., F-001) may be received from a particular vending machine. Such inventory data may indicate a number of units sold with respect to one or more product types (e.g., 18 units of Snickers® candy bars were sold in fill period F-001). A profit margin associated with a particular product type may be indicated by, or otherwise inferable from, a product database 125. In this manner, a controller may determine (i) a total amount of profit generated by sales of a particular product type during a fill period (e.g., 18 units of Snickers® candy bars were sold at a profit margin of 25¢ per unit, and therefore $4.50 in profit was generated from those sales), and (ii) a total amount of profit generated by a vending machine during a fill period (e.g., sales of all products via the vending machine generated a gross margin of $28.70 during the fill period). Thus, a controller may determine that a profit contribution percentage associated with a product type (e.g., the profit contribution of Snickers® candy bar is $4.50 divided by $28.70=15.68%, which means that sales of Snickers® candy bar accounted for almost 16% of the profit the vending machine made during the fill period F-001). An indication of such a profit contribution of a product type, which may be associated with one or more vending machines and/or fill periods, may then be stored in a product database 125. As described herein, a scoring process may then determine a profit contribution score associated with a product type based on the product type's profit contribution percentage.

In further embodiments, determining the profitability of a product may comprise determining an “expected profitability” associated with the product. In an embodiment, an expected profitability calculation may comprise determining an amount of profit that a vending machine operator may expect to realize from the sale of one or more products within a given period of time (e.g., an upcoming fill period).

Thus, in an embodiment, the expected profitability of a particular type of product (e.g., Snickers®) to be loaded into a vending machine during a particular period of time (e.g., upcoming fill period F-002) may be determined by multiplying the product's profit margin by the number of units of product expected to sell (i.e., a sales forecast metric).

A variety of sales forecast metrics and methods of forecasting product sales may be employed. In an embodiment, a sales forecast metric may be determined based on a product's actual prior (historic) sales rate. For example, if 18 units of Snickers® candy bars were sold via a particular vending machine during a previous 14-day fill period F-001 (e.g., a sales rate of 1.28 units/day), Snickers® candy bars may be predicted to sell at the same rate during an upcoming fill period F-002 (if, for example, the product is stocked in the same vending machine or in a vending machine situated in a location that has a similar profile). Thus, an expected profitability associated with loading Snickers® candy bars into the vending machine for an upcoming 14-day fill period may be determined by multiplying 18 (the number of units of Snickers® sold during a previous 14-day fill period) by 25¢ (the per-unit profit margin of Snickers®), such that the expected profitability associated with Snickers® sales during an upcoming fill period F-002 may be $4.50. Such expected profitability data may then be stored in a product database 125 in association with a product identifier (e.g., SN-1), fill period identifier (e.g., F-002), and/or one or more machine identifiers (e.g., M-001). As detailed later herein, a scoring process may then determine an “expected profitability” score associated with a product type based on the product type's expected profitability. An actual sales rate may describe a sales rate achieved during any period of time, including (i) previous fill periods that have concluded, and (ii) active or not-yet-concluded fill periods. Thus, such information on actual sales rates can be used in preparing for an upcoming fill period even before a vending machine is scheduled to be restocked.

A variety of other sales forecast metrics are contemplated. In an embodiment, a sales forecast metric may consider historic inventory data associated with a plurality of vending machines. For example, when determining an inventory allocation for a particular vending machine, historic sales figures for a number of vending machines situated in similar locations (e.g., inventory data associated with all vending machines situate din public high schools) may be used. Consulting such data may allow a vending machine operator (and/or a computer or like device) to determine which products have historically been popular during a particular period of time, and perhaps more specifically, an average number of units of a particular product type purchased during a period of time at all vending machines associated with the same “location profile” (e.g., high school students purchase an average of 35 Twix® candy bars from a vending machine during an average December month). Thus, a vending machine operator may use inventory data from a plurality of vending machines to determine a sales forecast metric associated with a product type (e.g., 35 Twix® candy bars), such that an expected profitability may then be determined (e.g., if a per-unit profit margin associated with Twix® candy bars is 15¢, an expected profitability may be 35×$0.15=$5.25 for December).

In an embodiment, a sales forecast metric may consider “soft demand” data (which is described herein). For example, in an embodiment, a vending machine customer may indicate a desire to purchase a particular product type but the customer may not actually buy any units of that product (such “soft” customer demand may then not be indicated by inventory data). For example, a customer may have attempted to purchase an out-of-stock product during a previous fill period (e.g., the customer approached a “bubble front” machine in which inventory is not visible, and selected a product that was not in stock). In another example, a customer may actuate a vending machine input device to indicate their desire to purchase products that are not stocked in a particular vending machine (e.g., a touch-sensitive LCD screen indicates, “Don't see what you're looking for? Tell Us!”). Further, a customer may indicate such desire by calling a telephone number or sending an e-mail to an address indicated by the vending machine. In this manner, a controller may record, for a fill period, a number of units of a particular product type that were not stocked (e.g., F-001) but that customers may desire to purchase during one or more subsequent fill periods (e.g., F-002-F-00N). The number of units of a particular product type requested during a particular fill period (i.e., soft demand) may then, for example, be added to a number of units of the product type sold during the fill period, such that a controller may then determine a “sales rate including soft demand”. One example formula for calculating a “sales rate including soft demand” is:

$$\frac{\begin{matrix}( £ of units of SN \text{-} N sold during F \text{-} 001 ) + \\ ( £ of units of SN \text{-} N requested during F \text{-} 001 )\end{matrix}}{£ of days in F \text{-} 001}$$

A sales rate including soft demand may then be used as a sales forecast metric for the purposes of calculating an expected profitability associated with the product type (e.g., the per-unit profit margin of SN-N is multiplied by the sales rate including soft demand). Such expected profitability data may then be stored in a product database 125.

Soft Demand Data. In an embodiment, inventory management data may be separately consider soft demand data (e.g., a “soft demand score” based only on soft demand data is determined, as opposed to determining an expected profitability score that is based in part on a sales metric considering soft demand). Soft demand data may be received from and associated with one or more vending machines as described herein.

For example, in an embodiment, a controller may track a number of units of a particular product type not stocked during a fill period (e.g., F-001) that customers may desire to purchase during one or more upcoming fill periods (e.g., F-002-F-00N). As stated, customers may indicate such desire for unavailable products by (i) attempting to purchase an out-of-stock product, and/or (ii) actively indicating their desire to purchase one or more products not included as part of a previous or current particular vending machine inventory allocation (e.g., selecting an icon representing the product PayDay® candy bar after that icon is displayed via a touch-screen along with the instruction: “Tell us which products you'd like to see”). In an embodiment, a product database 125 may indicate a number of units of “soft demand” associated with a particular product type. For example, turning to FIG. 5B, four customers of vending machine M-001 may have indicated a desire to purchase Snickers® candy bar during fill period F-001. A variety of product types may then be ranked based on soft demand data as described further herein.

Subscription Account Data. In an embodiment, a vending machine customer may register for a subscription account. In one such example, a customer may (i) establish a prepaid unit account, and (ii) use an access code associated with the account (e.g., a numeric identifier) when redeeming products from the vending machine, such that a unit balance is debited in accordance with each redemption. As stated, vending machine subscription accounts are described at length in Applicant's PCT Patent Application No. US 2004/041561, entitled PRODUCTS AND PROCESSES FOR ESTABLISHING MULTI-TRANSACTION RELATIONSHIPS WITH CUSTOMERS OF VENDING MACHINES, filed Dec. 9, 2004; U.S. Pat. No. 6,298,972, entitled METHOD AND APPARATUS FOR ESTABLISHING AND MANAGING VENDING MACHINE SUBSCRIPTIONS, issued Oct. 9, 2001; U.S. Pat. No. 6,085,888, entitled METHOD AND APPARATUS FOR ESTABLISHING AND MANAGING VENDING MACHINE SUBSCRIPTIONS, issued Jul. 11, 2000; U.S. Pat. No. 5,988,346, entitled METHOD AND APPARATUS FOR ESTABLISHING AND MANAGING VENDING MACHINE SUBSCRIPTIONS, issued Nov. 23, 1999; Patent Application No. US2004/041561, entitled PRODUCTS AND PROCESSES FOR ESTABLISHING MULTI-TRANSACTION RELATIONSHIPS WITH CUSTOMERS OF VENDING MACHINES, filed Dec. 9, 2004; and Patent Application No. 60/668,405, entitled PRODUCTS AND PROCESSES FOR ESTABLISHING MULTI-TRANSACTION RELATIONSHIPS WITH CUSTOMERS OF VENDING MACHINES, filed Dec. 9, 2004. The entirety of each of the above patents and patent applications is incorporated by reference herein as part of the present disclosure.

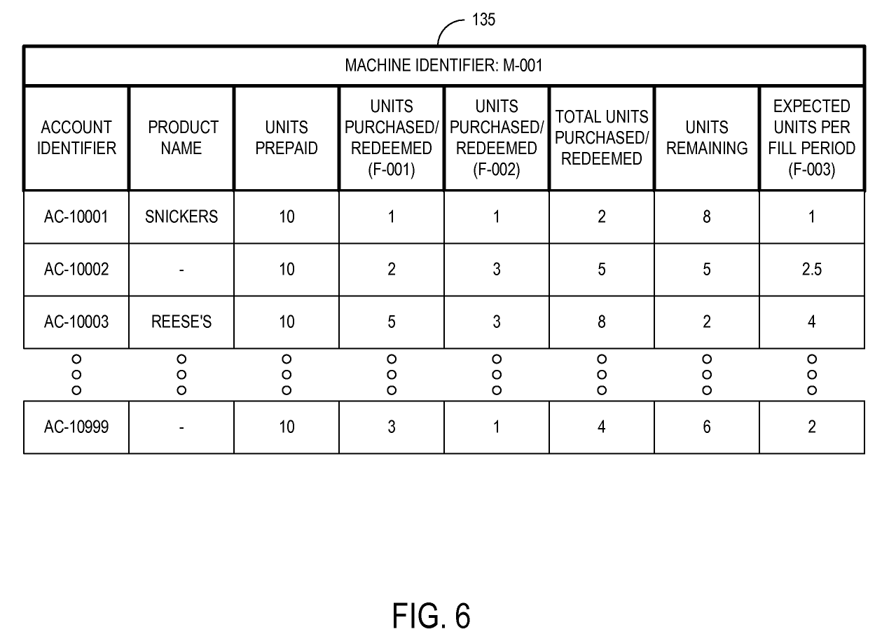

In an embodiment of the present invention, inventory management data may comprise subscription account data. In an embodiment, a customer registering a subscription account may indicate one specific product types that are to be associated with the account, such that the customer may only redeem items from the particular product type once the account is established. Turning to an exemplary data structure of a subscription account database 135 depicted by FIG. 6, a customer associated with subscription account “AC-10001” may indicate that Snickers® candy bars (SN-1) are to be associated with the subscription account identifier. Accordingly, the customer may fund the account such that the customer may then be entitled to redeem a number of units of Snickers® candy bars (e.g., ten units). The customer's redemption behavior may then be recorded (e.g., data representing the customer's redemptions is stored in a subscription account database that is associated with the account identifier), such that a vending machine and/or controller may determine (i) a total number of units remaining in the subscription account (e.g., if the customer is entitled to ten units of Snickers® candy bars and has only redeemed two units, the customer is still entitled to eight units), and/or (ii) an “expected number of units redeemed per fill period,” which may indicate a number of units of product that the customer may be expected to redeem during an upcoming fill period. A variety of methods of calculating an expected number of units redeemed per fill period may be employed. In an embodiment, an expected number of units redeemed per fill period may represent an average of the number of units redeemed during a plurality of fill previous periods (e.g., turning to FIG. 6, if the customer redeemed one unit of Snickers® candy bars during a first fill period F-001, and one unit of Snickers® candy bars during a second fill period F-002, the customer may be expected to redeem one unit of Snickers® candy bars during an upcoming fill period F-003).

In an embodiment, a vending machine and/or controller may then determine a number of units of a particular product type that should be stocked during an upcoming fill period in order to satisfy the demand of a customer with a product-specific subscription account. Accordingly, in one example, a vending machine and/or controller may determine an expected number of units redeemed per fill period associated with a plurality of customers (e.g., five Snickers® candy bars must be loaded into vending machine M-001 during an upcoming fill period F-002 in order to meet the expected demand associated with such customers holding product-specific account subscriptions). Thus, a “subscription units” field associated with Snickers® candy bars may be populated in a product database 125 that is associated with vending machine M-001 (e.g., as in FIG. 5B). In an embodiment, if the number of “units remaining” associated with a subscription account is less than the expected number of units to be sold per fill period, a subscription units field of a product database 125 may be populated instead with the number of units remaining (e.g., such that four units of Reese's® candies are not stocked for a customer if the customer is only entitled to two). Product types may then be ranked based on subscription data during a scoring process described herein, such that when determining a vending machine inventory allocation, inventory management data comprises outstanding subscription account data.

In other embodiments, a vending machine customer may register for a subscription account that is not product-specific (e.g., a subscription account entitling the customer to redeem a variety of product types of a particular designated category, such as cans of soda). Accordingly, a vending machine and/or controller may be configured to detect a “purchase pattern” associated with such a customer, such that an expected number of units per fill period may be determined (e.g., although a customer has not registered to purchase a specific item, if the customer frequently purchases Diet Coke®, an expected number of units per fill period may be associated with Diet Coke®). For example, in an embodiment, a vending machine and/or controller may receive an account identifier (e.g., a customer approaches a vending machine during fill period F-001 and enters a set of numeric characters using a touch-sensitive LCD screen), and store subscription data associated with the account identifier (e.g., if the customer enters the code and redeems a Diet Coke® soda, a “units purchased” record of a subscription account database 135 is updated to reflect that redemption during fill period F-001). Such redemptions may then be recorded in an ongoing manner (e.g., product selections associated with a particular subscription account are monitored over the course of several fill periods). In this manner, a vending machine and/or controller may determine an expected number of units to be redeemed per fill period as described.

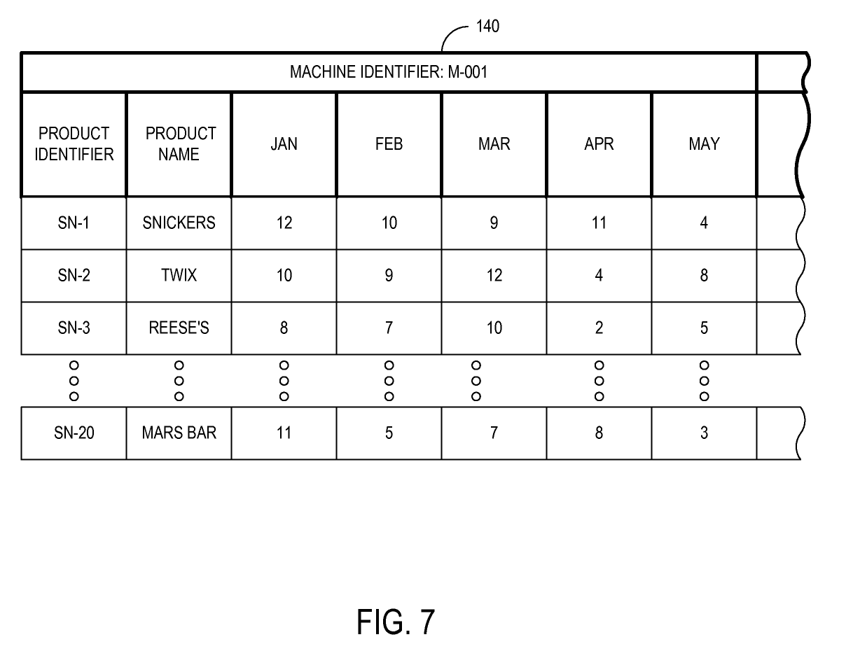

Seasonality Data. In an embodiment, inventory management data may comprise seasonality data. As described, in an embodiment, a vending machine and/or controller may determine a sales rate associated with a product type (e.g., an average number of units of a particular product type sold per day). In an embodiment, a sales rate associated with a particular product type may be determined for each month of the year (e.g., a sales rate associated with Snickers® candy bars in January, February, etc.) in which the product was stocked in one or more vending machines. Any other period of time besides months (e.g., weeks, three-month seasons) may be used in a similar manner. Thus, turning to an exemplary data structure of a product seasonality database 140 depicted by FIG. 7, a product type may be given a score (e.g., from 1 to 12) for each month of the year, based on a product sales rate (e.g., a relative score of 12 being awarded to the month in which the product has the highest sales rate). Such scores may alternately or additionally be based on scores that are specified by the operator (e.g., an operator dislikes loading chocolate-based products during the summer time, such that Snickers® is given a low score). Such seasonality data may then be used in a scoring/ranking process described herein, such that an inventory allocation may be based at least in part on seasonality considerations.

Tenure Data. In an embodiment, an inventory management data may comprise product tenure data. For example, in an embodiment, it may be advantageous to maintain certain mature product types in inventory (e.g., customers may be accustomed to seeing a particular well-known product type in a vending machine). Accordingly, a record of a product database 125 associated with a particular product type may indicate an amount of time (e.g., in months) that such a product has been stocked in one or more particular machines. Such tenure data may be useful in determining (i) which products are long-standing products that customers may have come to expect in inventory (e.g., Snickers®), as well as (ii) newer products, including product types that have not yet been stocked in a particular machine. Tenure data may then be used in a scoring/ranking process described further herein, such that an inventory allocation may be based at least in part on product tenure considerations.

Weather Data. In an embodiment, inventory management data may comprise a weather forecast. In an embodiment, a database may indicate a weather condition associated with a product type. For example, the weather condition “85° or less” may be associated with Snickers® candy bar, such that if a projected temperature (e.g., tomorrow's forecasted temperature, the forecasted average temperature for the next fill period) is higher that 85° F., Snickers® candy bars (i) may be given relatively a low score during a scoring process, or (ii) may be given a score of “suppress.” Other weather conditions besides temperatures may be employed.

Price Data. In an embodiment, inventory management data may comprise price data. For example, a retail price associated with each product type may appear as a record of a product database 125. Price data may then be considered when determining an inventory allocation. For example, it may be desirable to have a vending machine stocked with products that are primarily or exclusively high priced, or low priced.

Expiration. In an embodiment, inventory management data may comprise expiration data. For example, in an embodiment, a product database 125 (e.g., a product database detailing information regarding a universe of products available to an operator, such as the database depicted by FIG. 5A) may indicate an expiration date in association with a product type or a particular unit of product. Accordingly, scores may be assigned to each product type (or individual unit of product) based on the respective expiration dates. For example, a product with a expiration date which is relatively soon may receive a high score, whereas a product with an expiration date in the distant future may receive a relatively low score. Thus, products that will soon expire may be more likely to be included or excluded in one or more inventory allocations.

Demographic. In an embodiment, inventory management data may comprise demographic or other marketing data associated with one or more vending machines. Thus, a vending machine located in an area that has certain characteristics (e.g. an urban setting, predominantly male customers), then certain products that are successful in other vending machine locations may be given certain prominence in the inventory allocations rules. For example, in one such embodiment, only products that sell at a particular rate in similar locations may be considered in the inventory allocation process. Further, in another embodiment, products that typically sell in similar locations may be accorded greater weight in a scoring process.

Rebates. In an embodiment, inventory management data may comprise data indicating a benefit a third party provides to the operator in exchange for selling or offering a product type. For example, the operator may be provided with (1) discounts or rebates from a wholesale distributor in exchange for selling certain product types and/or buying inventory in certain quantities, (2) discounts from the manufacturer for selling/stocking products of the manufacturer.

### Determinations

As described, inventory management data may comprise various different types of data (e.g., a product database 125 comprises sales rate data, expected profitability data, soft demand data, tenure data, subscription data, and so on—any or all of which may be associated with a particular product type and/or one or more fill periods). Some inventory management data (e.g., expected profitability data, soft demand data) may be associated with a particular vending machine, whereas data associated with other inventory management factors (e.g., seasonality data) may be generally associated with a product type, regardless of the vending machine in which the product is stocked.

Accordingly, when determining an inventory allocation for a particular vending machine (e.g., M-001) for an upcoming fill period (e.g., F-002), a controller may access a product database 125. In an embodiment, product data may be associated with the machine (e.g., as depicted by FIG. 5B, a product database 125 associated with M-001). Alternately or additionally, product data may be associated with a plurality of machines (e.g., as depicted by FIG. 5A, a product database 125 is associated with vending machines M-001 through M-100). Also, such a product database 125 may comprise (i) data that is specific to one or more particular fill periods, and/or (ii) data that is generally associated with product types available to an operator, regardless of fill period. Thus, a product database 125 may comprise product data associated specifically with vending machine M-001 during fill period F-001, but may also contain general product data (e.g., seasonality data) associated with product types available to the operator that may never have been previously loaded in machine M-001.

Data maintained in a product database 125 may be used in a scoring/ranking process, the results of which may be used to determine (i) which product types are to be loaded into a vending machine (e.g., M-001), and (ii) how many units of each type of product are to be loaded (e.g., how many rows the product type will occupy).

In an embodiment, a controller may first determine vending machine configuration data. For example, in an embodiment, a controller may determine a model number associated with a vending machine. A database (not shown) may then indicate various configuration attributes associated with the vending machine model number (e.g., vending machine M-001 contains 25 product rows, each of which comprises a helix into which 10 units of product may be loaded). In this manner, before scoring/ranking product types in order to determine an inventory allocation associated with a particular vending machine, a controller may determine (i) how many different product types a machine may be capable of holding at once (e.g., 25 different types if a different product type may be associated with each row of vending machine M-001), (ii) a number of units associated with each row (e.g., each row of vending machine M-001 holds up to 10 units of product), and/or (iii) a total number of units which a vending machine may hold at once (e.g., up to 250 units, which is 25 rows×10 units per row). Processes of determining a vending machine configuration is well known.

A controller may then perform a scoring/ranking process to determine which product types are to be loaded in a vending machine. For example, up to twenty five product types may be loaded in machine M-001, though an operator may choose to load more than one product type in each row. Such methods are described in Applicant's pending patent application Ser. No. 10/951,296, entitled “METHOD AND APPARATUS FOR DETERMINING AND UTILIZING PRODUCT LOCATION IN A VENDING MACHINE,” the entirety of which is incorporated herein by reference as part of the present disclosure. Thus, in an embodiment, a scoring/ranking process may serve to (i) determine inventory management scores associated with each available product type, (ii) rank the product types based on the scores, and (iii) determine an inventory allocation based on the ranking. Each of these steps is described immediately below.

In an embodiment, a controller, vending machine and/or peripheral device may determine inventory management scores based on the data stored in a product database 125.

A controller, vending machine and/or peripheral device may first determine that one or more product types (if any) are either required or suppressed due to slotting requirements. For example, according to a product database, “Mars® Bars” are required, and thus must be included in vending machine M-001. Further, if Twix® candy bars are determined to be part of an inventory allocation, Snickers® candy bars must also be included (in other words, Snickers® candy bars are required, conditioned upon Twix® candy bars being a part of an inventory allocation). Still further, Reese's® candies may be allowed in vending machine M-001 (as they are only to be suppressed from machine M-004). In an embodiment, such slotting requirements may ensure that a particular product type is included (or suppressed) as part of an inventory allocation, but such slotting requirements need not have any bearing on the number of rows into which the required/suppressed product type is stocked or the number of units of the required/suppressed product type are to be stocked (since such a determination may be based on other product data). In an alternate embodiment, a “slotting requirement” field of a product database 125 may also describe a minimum number of rows into which a product should be loaded (e.g., “Include, 2 Rows”) and/or a minimum number of units to be stocked. Similarly, a “slotting requirement” field of a product database 125 may also describe a maximum number of rows into which a product should be loaded (e.g., “Include, up to 4 Rows”) and/or a maximum number of units to be stocked.

A controller may then determine inventory management scores associated with particular categories of inventory management data. For example, data may be available for forty product types SN-1 through SN-40, though a vending machine M-001 may only be able to accommodate a lesser number of product types (e.g., twenty five). Thus, a scoring process associated with an inventory management factor (e.g., profit margin) may, in an embodiment, assign a relative numeric score (e.g., from 1 to 40) to a product type based on the product data.

For example, turning to FIG. 5A, each of the forty product types SN-1 through SN-40 may be assigned a relative score based on their per-unit profit margin, in which “40” is awarded to the product type with the highest margin, and “1” being awarded to the product type with the lowest margin. In an embodiment, an averaging process may be used to determine scores if data indicates that two or more product types have the same margin. For example, if Twizzlers® candies and Dentyne® gum both have a profit margin of 1¢ (where 1¢ is the lowest profit margin of all products SN-1 through SN-40), then Twizzlers® candies and Dentyne® gum would each be given a score of “1.5” (as a total of “3” points—the sum of 1 and 2—are to be awarded between the two products with the lowest margin).

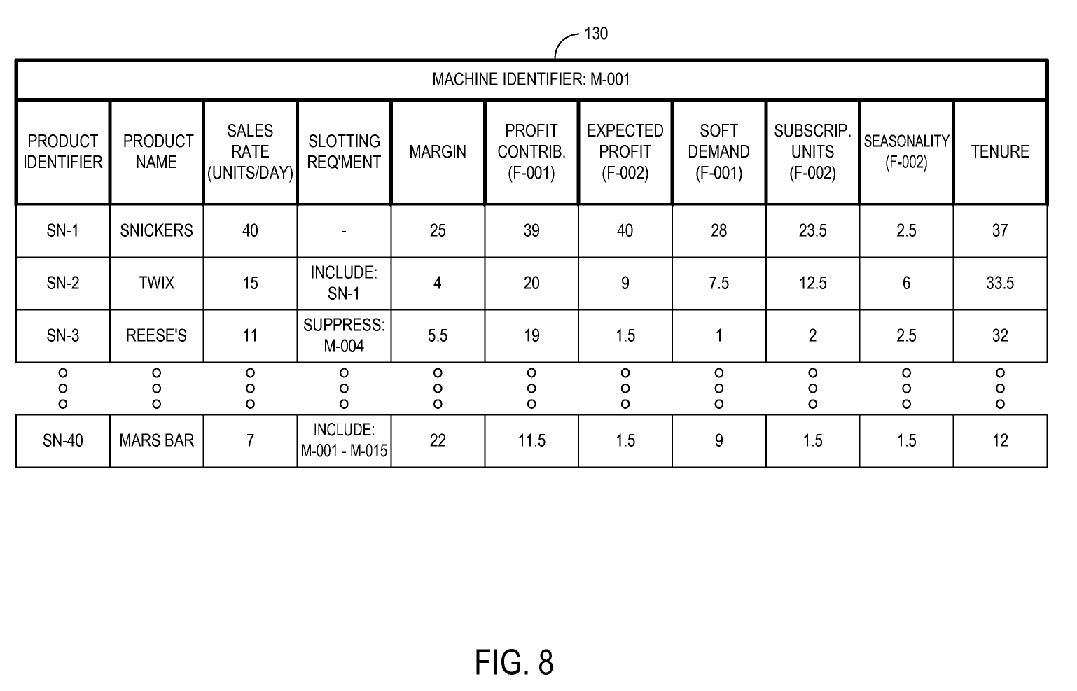

Scores may then be assigned to all product types with respect to each category of product data. In an embodiment, the result of such a scoring process may be recorded in a product scoring database 130, an exemplary data structure of which is depicted by FIG. 8. In this manner, all available product types may be scored based on their relative strength with respect to a variety of categories. For example, product types are ranked according to their expected profitability in a substantially similar manner to that described above with reference to ranking product types based on their margin.

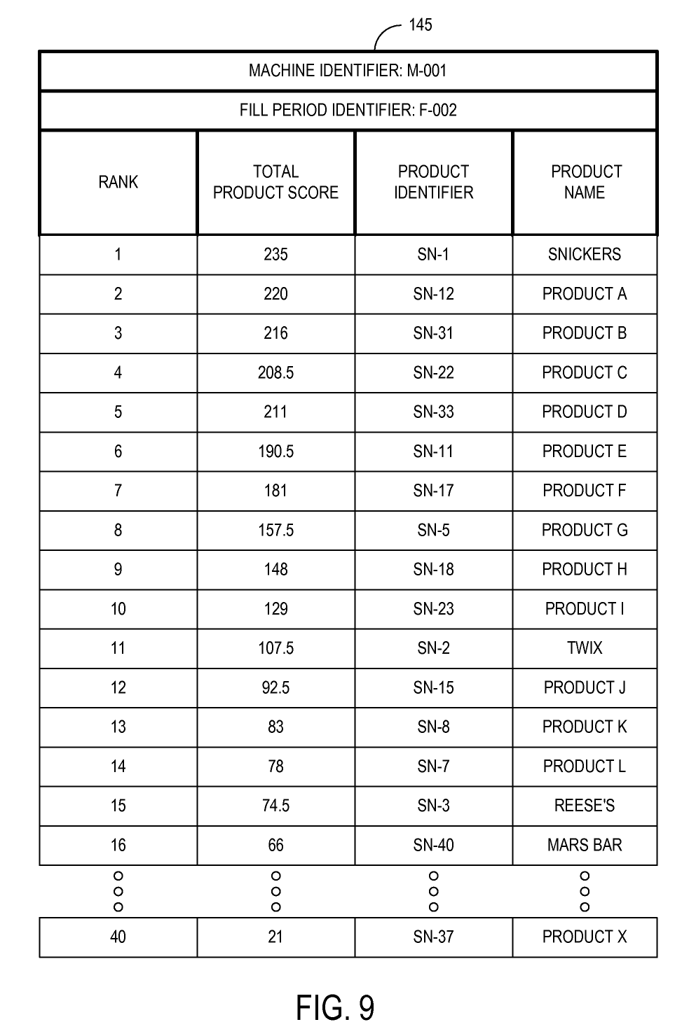

In an embodiment, a controller may rank the available product types based on the data stored in the product scoring database 130. For example, a controller may total all the scores associated with each product type indicated by a product scoring database 130, as well as sort the total scores from highest to lowest. In an embodiment, the result of such a process may be recorded in a product ranking database 145, as depicted by FIG. 9 (e.g., Snickers® is ranked highest, with a total score of 235).

In another example, before arriving at a total score, a controller may first apply a “weight metric” or multiplier to a score associated with a particular category of inventory management data. For example, “soft demand” may have a weight metric of “1,” whereas “expected profitability” may have a weight metric of “2.5”. Thus, the weight of expected profitability is greater than the weight of soft demand, indicating that expected profitability would be considered more relevant in determining a total score than soft demand would.

Turning to a product scoring database indicated by FIG. 8, a controller may then calculate a total score associated with Snickers® candy bars. Accordingly, an “expected profitability” score of “40” may be multiplied by 2.5 before arriving at a total (such that the “expected profitability” score for Snickers® candy bar becomes “90”), whereas a “soft demand” score of “28” may remain unchanged (i.e., 28×1=28). In this manner, an operator may assign various weights to different inventory management factors, such that some factors may play a larger role in determining a total product score (e.g., expected profitability may be deemed to be a more important factor than soft demand).

In an embodiment, certain categories may be considered, while others may not (e.g., a total score associated with a product may not consider all available categories). For example, a controller may determine a product ranking based on inventory data and one other category (e.g., soft demand and inventory data scores are added together for a number of product types, and the product types are subsequently ranked based on the totals).

Thus, one advantage associated with various embodiments is the ability for operators to determine inventory allocations based on product ranking processes that consider selected inventory management factors and associated weight metrics (e.g., an operator can, if desired, customize which factors and weight metrics are to be applied).

A controller may then determine an inventory allocation based at least in part on the data stored in the product ranking database 145. For example, in an embodiment, vending machine M-001 comprises 25 rows. Accordingly, in an embodiment, a controller may select products ranking from 1 to 25 (i.e. the highest twenty five ranked products) as indicated by a product ranking database, such that each product type may be assigned to one row of vending machine M-001 during an upcoming fill period F-002 (e.g., Snickers® candy bars will be loaded in one row, “Product A” will be loaded in one row, and so on until the 25^{th}-ranking product).

In an embodiment, an operator may choose to stock one product type in more than one row (e.g., if the Snickers® candy bar has scored particularly high with regard to one or more categories, it may be advantageous to include Snickers® candy bars in more than one row of the vending machine).

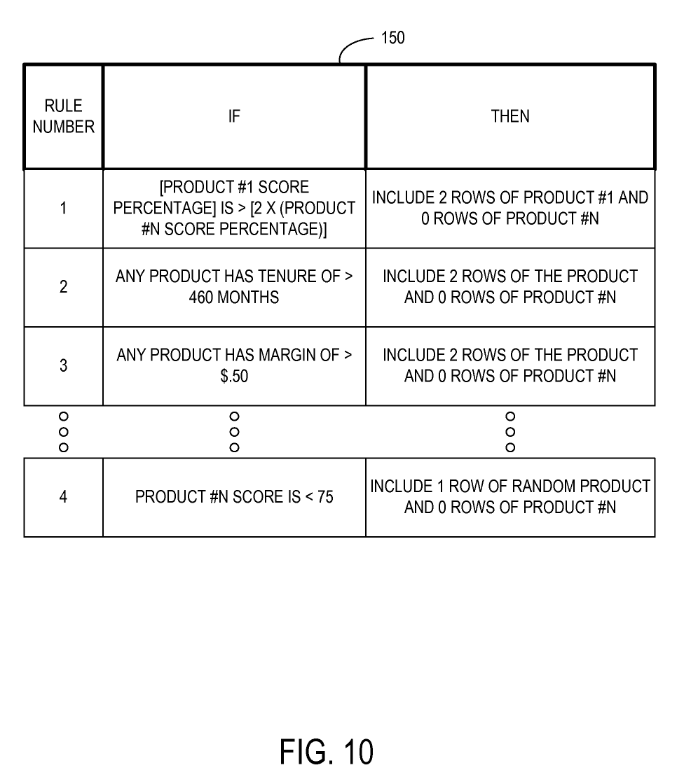

Further, in an embodiment, a stored inventory allocation rule (e.g., an “if/then” condition stored within an allocation rules database 150, as depicted by FIG. 10) may instruct a controller to allocate more than one row to a particular product type if certain conditions are satisfied. In one example, an operator may determine an inventory allocation for a vending machine that has 15 rows. First, a scoring/ranking process as described above may be performed, such that the 15 highest-ranking products of all available products may be determined in association with a particular vending machine and fill period. Accordingly, in one example, with reference to FIG. 9, the product scores associated with each product ranking from 1 to 15 may be added together, so as to arrive at a “total allocation score” of “2332.” A “product score percentage” may then be determined in association with each individual product type, in which the product score percentage of a particular product type defines the portion of the total allocation score that is attributable to that particular product type. For example, if the product score for Snickers® candy bar is 235 and the total allocation score is 2332, a product score percentage associated with Snickers® candy bar may be approximately 10% (i.e., 235/2332×100). Continuing with the example, if the product score for Reese's® candies is 74.5 and the total allocation score is 2332, a product score percentage associated with Reese's® candies may be approximately 3% (i.e., 74.5/2332×100). Accordingly, in an embodiment, a stored inventory allocation rule (e.g., Rule #1 of an allocation rules database 150 depicted by FIG. 10) may then indicate to assign Snickers® candy bars to two rows and Reese's® candies to no rows. Thus, Reese's® candies (i.e., “PRODUCT #N”), being the 15^{th}-ranked product in a 15-row machine, may be eliminated from an inventory allocation such that another product (e.g., Snickers® candy bars) may be stocked in more than one row.

In another example (e.g., “Rule #2” and “Rule #3” of FIG. 10), a stored inventory allocation rule may allow for a product characterized by certain inventory management data (e.g., tenure data, margin data) to supplant another product (e.g., a product with a higher margin is assigned to two rows, while a low-ranking product or a product with a low margin is assigned to no rows).

In other embodiments, a controller may determine a number of rows to be occupied by a particular product type based on the product score associated with the product. For example, turning to FIG. 9, when determining an inventory allocation for a vending machine having 15 rows, a controller may allocate one row for every 100 points (or any other amount of points) totaled by a product type during a scoring process. Thus, continuing with the example, an inventory allocation for the vending machine may appear as follows:

| | |
|---|---|
| ROW 1 | SNICKERS ® (Score: 235) |
| ROW 2 | SNICKERS ® (Score: 235) |
| ROW 3 | PRODUCT A (Score: 220) |
| ROW 4 | PRODUCT A (Score: 220) |
| ROW 5 | PRODUCT B (Score: 216) |
| ROW 6 | PRODUCT B (Score: 216) |
| ROW 7 | PRODUCT C (Score: 208.5) |
| ROW 8 | PRODUCT C (Score: 208.5) |
| ROW 9 | PRODUCT D (Score: 211) |
| ROW 10 | PRODUCT D (Score: 211) |
| ROW 11 | PRODUCT E (Score: 190.5) |
| ROW 12 | PRODUCT F (Score: 181) |
| ROW 13 | PRODUCT G (Score: 157.5) |
| ROW 14 | PRODUCT H (Score: 148) |
| ROW 15 | PRODUCT I (Score: 129) |

Such a method may be beneficial, as product types may be accorded a greater number of rows if they achieve a score above a certain threshold. Accordingly, a vending machine may be stocked with a high proportion of higher-scoring products.

In other embodiments, determining an inventory allocation may comprise, (i) determining a number of product types, and (ii) determining a number of units associated with each product type, wherein the number of units determined does not necessarily correspond to a number of units associated with one or more particular rows of a vending machine. In other words, the determined number of units associated with each product type need not be a multiple of the total number of units that a row may accommodate. For example, even though a vending machine row holds 10 units of product, a controller may determine that an inventory allocation comprises 17 units of Snickers® candy bars and 13 units of Twix® candy bars. In an embodiment, more than one product type may then be loaded into a particular row (e.g., the vending machine is loaded such that a first row contains 10 units of Snickers®, a second row contains 10 units of Twix® and a third row contains 7 units of Snickers® and 3 units of Twix®). For example, a total score may be determined in association with each product type such that the product types may be ranked, and a product score percentage may be determined as described herein.

A vending machine configuration may then be determined (e.g., the vending machine to be loaded comprises 10 rows, each capable of holding 10 units of product, so the vending machine may accommodate 100 units). Accordingly, the number of units of each product type to be loaded may be determined based on the product score percentage. For example, if a product score percentage for Snickers® candy bars is 33%, 33 units of Snickers® candy bars are to be loaded. For example, three full rows are to be filled with Snickers®, as well as 3 units in a fourth row, and the fourth row may include other product types as well. In an embodiment, a conventional shelf-style vending machine may store more than one product type in each row (e.g., if a row may hold 10 units of product, 7 units of Twix® bars are loaded in the front of the row and the aforementioned 3 units of Snickers® candy bars are loaded in back). Such embodiments are described in Applicant's pending patent application Ser. No. 10/951,296, Attorney Docket No. 03-059, entitled “METHOD AND APPARATUS FOR DETERMINING AND UTILIZING PRODUCT LOCATION IN A VENDING MACHINE,” the entirety of which is incorporated herein by reference as part of the present disclosure.

In an embodiment, an operator may desire to include at least one “random” product type when determining an inventory allocation (e.g., in order to test different product mixes). Accordingly, a controller may determine to remove or “replace” a predetermined number of products (e.g., the lowest-ranking product) from an inventory allocation in favor of a random product that was not originally determined as part of the allocation. In one such method, turning to FIG. 10 (Rule #4), a product scoring beneath a threshold amount of points may be removed in favor of a random product. A controller may determine a random product type in a variety of manners (e.g., by generating a random number associated with a product identifier, by receiving a manual selection of a random product type from an operator, etc.).

The replacement of certain products (e.g., the replacement of the ten lowest ranking products) may be accomplished in manners besides random selection of one or more replacement products. For example, the selection of replacement products may be based on, e.g., factors and methodologies employed in ranking (e.g., profit contribution) as well as factors such as popularity, consumption, characteristics of the vending machine (e.g., demographic data), and attributes of products that are selling well at the vending machine.

In this manner, new product types may be introduced to consumers at any rate desired, even frequently or continually (e.g., such that customers do not become bored with a particular mix of products, such that demand for new product types may be tested), and inventory allocations may be said to “evolve” between fill periods.

In an embodiment, an operator may determine an inventory allocation for a new vending machine (e.g., a vending machine is placed in a new location, such that there is no inventory data associated with the vending machine or the location). Accordingly, in an embodiment, a “standard allocation” may be used for that vending machine. A standard allocation may be determined, for example, by compiling data from all vending machines maintained by the operator (e.g., averaging sales rates, soft demand metrics, expected profitability), and subsequently performing a ranking process as described herein. In another embodiment, an inventory allocation for a new vending machine (e.g., placed in a highway rest stop) may be determined by compiling all data associated with vending machines characterized by a similar location profile (e.g., all vending machines located in high way rest stops, other environments wherein there may be few repeat customers, and so on).

In an embodiment, certain rows or shelves within a vending machine may be accorded a higher status than other rows or shelves. For example, it may be more desirable to stock low-selling or relatively unpopular items in shelves or rows that are at the customers eye-level, such that such products may be more likely to sell. Accordingly, in an embodiment, determining an inventory allocation may comprise determining a location within a vending machine wherein a product type should be stocked (e.g., stock Snickers® in row B-4). In an embodiment, rules stored in a database (not shown) may indicate which product types to assign to which rows (e.g., the two lowest-scoring products should be loaded in the first and second rows of the third shelf). In further embodiments, slotting requirement data may specify one or more rows or shelves associated with a product type (e.g., similar to in a supermarket, as producers may provides fees to an operator for premium shelf space).

In an embodiment, determining configuration data may comprise determining a number of products already loaded in a vending machine. For example, during a fill period, a vending machine may have sold three units of Snickers® candy bars, though seven units of Snickers® candy bars may remain. In an embodiment, it may be advantageous to restock the machine such that it is filled with a full row of Snickers® candy bars. Continuing with the above example, it may be determined that an inventory allocation must include one row of Snickers® candy bars. Accordingly, an operator may determine that only three units of Snickers® candy bars need be transported from a central facility to the vending machine location to satisfy the inventory allocation. In further embodiments, excess units of a particular product type may be transported from a central facility to a vending machine location to account for sales which may occur during transport (e.g., a few extra units of Snickers® candy bars are loaded onto a truck, such that if any additional units of Snickers® candy bars sell, a full row of Snickers® candy bars may still be loaded). In an embodiment, such “overstock inventory” may be based on a sales rate (e.g., if Snickers® candy bars sell at a rate of 1 unit/hour in association with a particular machine, and it takes 1 hour for a truck to reach the vending machine location, 1 extra unit of Snickers® candy bars may be loaded).

### Step 300: Output the Inventory Allocation

Once an inventory allocation associated with a vending machine is determined in step 200, the inventory allocation may be output during step 300. A variety of methods of outputting an inventory allocation may be employed.

In an embodiment, a display screen of a controller, peripheral device and/or vending machine may be configured to output an inventory allocation diagram. For example, a software program of a controller may be configured to output inventory allocation data to a display screen of the controller.

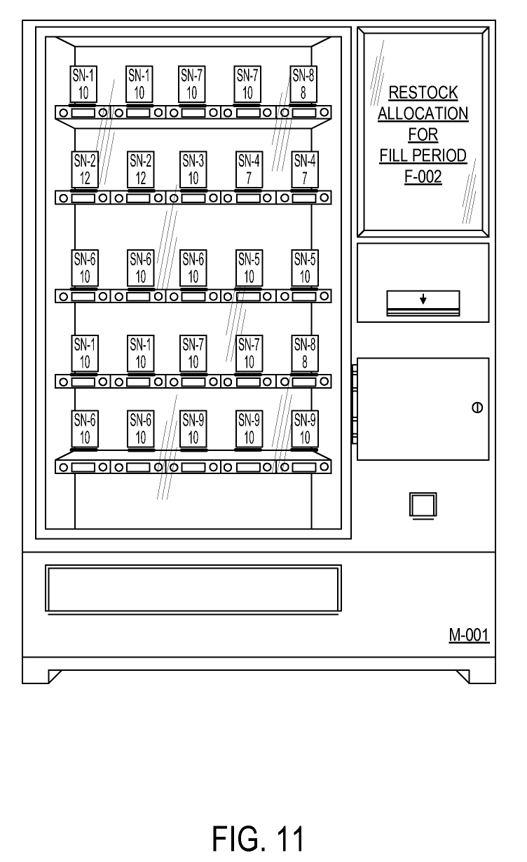

Such data may be output in any of a wide variety of forms. In an embodiment, inventory allocation data may comprise an image depicting a vending machine and the rows thereof. An example of such an image is depicted in FIG. 11. The image may also comprise product identifiers associated with the vending machine rows, and optionally, quantities associated with each product, such that a route driver may glance at the image and learn how the vending machine is to be restocked.

In another embodiment, inventory allocation data may be output in the form of a spreadsheet. In a further embodiment, a textual description of instructions for complying with an inventory allocation may be output (e.g., “Load 10 units of product SN-5 in row A-5”). Various processes for loading a vending machine are described in Applicant's pending patent application Ser. No. 10/951,296, Attorney Docket No. 03-059, entitled “METHOD AND APPARATUS FOR DETERMINING AND UTILIZING PRODUCT LOCATION IN A VENDING MACHINE,” the entirety of which is incorporated herein by reference as part of the present disclosure.

Alternately or additionally, a printer connected to a controller, peripheral device and/or vending machine may be configured to output an inventory allocation. For example, a vending machine may comprise a thermal printer as described, which may be configured to output inventory allocation data (e.g., an image similar to the image depicted in FIG. 11 may be printed by a vending machine before a restocking process, such that a route driver may view the image and load the machine).

In an embodiment, the device that performs step 200 (determining an inventory allocation) need not be the same device that performs step 300 (outputting the determined allocation). Accordingly, various devices may be configured to transmit inventory allocation data between one another. In one example, a controller 200 determines an inventory allocation, and transmits such data via communication network 210 to a vending machine 100, which then performs step 300.

In an embodiment, step 300 may be performed upon the request of an operator and/or route driver. For example, a controller may determine an inventory allocation during step 200. Subsequently, a route driver may approach a vending machine 100 and request that an inventory allocation may be output by actuating an input device (e.g., an interior button labeled, “Print Restock Configuration”). Accordingly, a controller 200 may receive the request and transmit the inventory allocation data via communication network 210, such that the vending machine 100 subsequently prints a diagram indicating an inventory allocation. In another embodiment, a route driver's truck may contain a variety of product types. Accordingly, when in proximity to a particular vending machine (e.g., the truck is parked outside of a building in which the machine is maintained), the route driver may request an inventory allocation from the vending machine (e.g., using a peripheral device such as a laptop computer with a wireless transceiver). The vending machine may then transmit inventory allocation data to the route driver (e.g., a wireless radio-frequency transmission is sent from the vending machine to the peripheral device) such that the route driver may determine, using the peripheral device, which product types to remove from the truck and load into the vending machine.

In yet another embodiment, a controller of the present invention (e.g., a computer maintained at a central facility of the operator) may output inventory allocation data to a peripheral device (e.g., a portable USB-based memory device, as described). Inventory allocation data may then be transmitted to a vending machine 100 via the peripheral device (e.g., the vending machine is programmed to read the data from the peripheral when the peripheral connects to the vending machine). In an embodiment, a vending machine 100 may be configured to output “loading instructions” based on the inventory management data. For example, a vending machine 100 may output a series of prompts to a route driver via a display screen, instructing the route driver to load a particular product type in a particular row (e.g., “Load Snickers in A-1, then press 0. Load Reese's in A-2, then press 0.”). Such an embodiment is described in Applicant's pending patent application Ser. No. 10/951,296, entitled “METHOD AND APPARATUS FOR DETERMINING AND UTILIZING PRODUCT LOCATION IN A VENDING MACHINE,” the entirety of which is incorporated herein by reference as part of the present disclosure.

In an embodiment, a vending machine, peripheral device and/or controller may store inventory allocation data, such that the inventory allocation data may be used during a load process to determine whether or not a route driver has loaded a vending machine correctly. Thus, in an embodiment, a vending machine, peripheral device and/or controller may be programmed or otherwise configured to output an error message to a route driver who fails to stock a vending machine in accordance with a determined inventory allocation. For example, if an inventory allocation for vending machine M-001 during the upcoming fill period F-002 calls for at least one row of product SN-1, an operator failing to load one row of SN-1 may be prompted with an error message via one or more output devices (e.g., a display screen depicts text reading “ERROR: MUST LOAD PRODUCT SN-1”).

We claim:

1. A method comprising:
determining a plurality of product types that are available to be sold via a vending machine;
determining inventory management data for each of the product types,
in which the inventory management data includes at least one of the following categories:
inventory data,
slotting requirement data,
profitability data,
subscription account data,
soft demand data,
seasonality data, and
product tenure data;
determining an inventory allocation based on the inventory management data for each of the product types, in which the inventory allocation specifies
a set of product types which are each selected from the plurality of product types; and
outputting an indication of the determined inventory allocation.

2. The method of claim 1, in which determining inventory management data comprises:
determining inventory management data from a plurality of fill periods.

3. The method of claim 1, in which the determined inventory allocation specifies
a set of product types which are each selected from the plurality of product types, and
for each product type of the set of product types, a number of units of the product type.

4. The method of claim 1, in which determining the inventory allocation comprises:
determining a number of rows of the vending machine; and
determining the inventory allocation based on the number of rows.

5. The method of claim 1, in which determining the inventory allocation comprises:
determining the inventory allocation based on at least one product type which is required.

6. The method of claim 1, in which determining the inventory allocation comprises:
determining the inventory allocation based on:
at least one product type, and
at least one row of the vending machine which must include the at least one product type.

7. The method of claim 1, in which a weight metric is associated with at least one category of inventory management data.

8. The method of claim 1, in which outputting an indication of the determined inventory allocation comprises:
a visual indication of:
a plurality of rows and
a corresponding product type from the set of product types for each respective row.

9. The method of claim 1, in which outputting an indication of the determined inventory allocation comprises:
a description of steps for loading the vending machine in accordance with the determined inventory allocation.

10. The method of claim 1, in which outputting an indication of the determined inventory allocation comprises:
printing the indication of the determined inventory allocation.

11. The method of claim 1, further comprising:
receiving inventory data for each of the product types,
determining a product ranking for at least some of the plurality of product types, in which the product ranking is determined based on
the inventory data and
at least one of the categories besides inventory data;
and in which determining the inventory allocation comprises:
determining the inventory allocation based on the product ranking.

12. The method of claim 1, further comprising:
applying a weight metric to at least one of the categories.

13. The method of claim 1, in which determining the inventory allocation comprises:
determining the inventory allocation based on inventory data and profitability data.

14. A method comprising:
determining inventory management scores for each of a plurality of product types that are available to be sold via a vending machine, in which the inventory management scores are based on at least one of the following categories:
inventory data,
slotting requirement data,
profitability data,
subscription account data,
soft demand data,
seasonality data, and
product tenure data;
in which the determining of inventory management scores includes consideration of a weight metric for at least one of the categories;
ranking each of the plurality of product types based on the inventory management scores;
determining an inventory allocation based on the ranking; and
outputting an indication of the determined inventory allocation.

15. The method of claim 14, in which the determining the inventory allocation comprises:
determining a number of rows of the vending machine; and
determining the inventory allocation based on the number of rows.

16. The method of claim 14, further comprising:
loading product types into a plurality of vending machines in accordance with the determined inventory allocation.

17. An apparatus, comprising:
a plurality of vending machines, in which each of the plurality of vending machines is loaded in accordance with the determined inventory allocation of claim 14.
